(19) United States
(12) Patent Application Publication
(10) Pub. No.: US 2004/0153430 A1
(43) Pub. Date: Aug. 5, 2004

(54) Method and apparatus for data analysis

(76) Inventor: Saed Sayad, North York (CA)

Correspondence Address: Eugene J. A. Gierczak, Suite 2500, 20 Queen Street West, Toronto, ON, M5H 3S1, CA

(21) Appl. No.: 10/668,354

(22) Filed: Sep. 24, 2003

Related U.S. Application Data
(60) Provisional application No. 60/412,810, filed on Sep. 24, 2002.

(51) Int. Cl. H04B 1/74

(52) U.S. Cl. 706/61

(57) ABSTRACT

A computer system, method and computer program product for enabling data analysis is provided. An analytical engine, executable on a computer, provides a plurality of knowledge elements from one or more data sources. The analytical engine is linked to a data management system for accessing and processing the knowledge elements. The knowledge elements include a plurality of records and/or variables. The analytical engine updates the knowledge element dynamically. The analytical engine defines one or more knowledge entity, each knowledge entity including at least one knowledge element. The knowledge entity, as defined by the analytical engine, consists of a data matrix having a row and a column for each variable, and the knowledge entity accumulates sets of combinations of knowledge elements for each variable in the intersection of the corresponding row and column. The invention provides a method for data analysis involving the analytical engine, including a method of enabling parallel processing, scenario testing, dimension reduction, dynamic queries and distributed processing. The analytical engine disclosed also enables process control. A related computer program product is also described.

### BACKGROUND OF THE INVENTION

Data analysis is used in many different areas, such as data mining, statistical analysis, artificial intelligence, machine learning, and process control to provide information that can be applied to different environments. Usually this analysis is performed on a collection of data organised in a database. With large databases, computations required for the analysis often take a long time to complete.

Databases can be used to determine relationships between variables and provide a model that can be used in the data analysis. These relationships allow the value of one variable to be predicted in terms of the other variables. Minimizing computational time is not the only requirement for successful data analysis. Overcoming rapid obsolescence of models is another major challenge.

Currently tasks such as prediction of new conditions, process control, fault diagnosis and yield optimization are done using computers or microprocessors directed by mathematical models. These models generally need to be “retrained” or “recalibrated” frequently in dynamic environments because changing environmental conditions render them obsolete. This situation is especially serious when very large quantities of data are involved or when large changes to the models are required over short periods of time. Obsolescence can originate from new data values being drastically different from historical data because of an unforeseen change in the environment of a sensor, one or more sensors becoming inoperable during operation or new sensors being added to a system for example.

In real-world applications, there are several other requirements that often become vital in addition to computational speed and rapid model obsolescence. For example, in some cases the model will need to deal with a stream of data rather than a static database. Also, when databases are used they can rapidly outgrow the available computer storage available. Furthermore, existing computer facilities can become insufficient to accomplish model re-calibration. Often it becomes completely impractical to use a whole database for re-calibration of the model. At some risk, a sample is taken from the database and used to obtain the re-calibrated model. In developing models, “scenario testing” is often used. That is, a variety of models need to be tried on the data. Even with moderately sized databases this can be a processing intensive task. For example, although combining variables in a model to form a new model is very attractive from an efficiency viewpoint (termed here “dimension reduction”), the number of possible combinations combined with the data processing usually required for even one model, especially with a large database, makes the idea impractical with current methods. Finally, often models are used in situations where they must provide an answer very quickly, sometimes with inadequate data. In credit scoring for example, a large number of risk factors can affect the credit rating and the interviewer wishes to obtain the answer from a credit assessment model as rapidly as possible with a minimum of data. Also, in medical diagnosis, a doctor would like to converge on the solution with a minimum of questions. Methods which can request the data needed based on maximizing the probability of arriving at a conclusion as quickly as possible (termed here “dynamic query”) would be very useful in many diagnostic applications.

Finally, mobile applications are now becoming very important in technology. A method of condensing the knowledge in a large database so that it can be used with a model in a portable device is highly desirable.

This situation is becoming increasingly important in an extremely diverse range of areas ranging from finances to health care and from sports forecasting to retail needs.

### FIELD OF THE INVENTION

The present invention relates to a method and apparatus for data analysis.

### DESCRIPTION OF THE PRIOR ART

The primary focus in the previous art has been to focus upon reducing computational time. Recent developments in database technology are beginning to emphasize “automatic summary tables” (“AST's”) that contain pre-computed quantities needed by “queries” to the database. These AST's provide a “materialized view” of the data and greatly increase the speed of response to queries. Efficiently updating the AST's with new data records, as the new data becomes available for the database has been the subject of many publications. Initially only very simple queries were considered. Most recently incrementally updating an AST in accordance with a method of updating AST's that applies to all “aggregate functions” has been proposed. However, although the AST's speed up the response to queries, they are still very extensive compilations of data and therefore incremental re-computation is generally a necessity for their maintenance. Palpanas et al. proposed what they term as “the first” general algorithm to efficiently re-compute only the groups in the AST which need to be updated in order to reply to the query. However, their method is a very involved one. It includes a considerable amount of work to select the groups that are to be updated. Their experiments indicate that their method runs in 20% to 60% of the time required for a “full refresh” of the AST. There is increasing interest in using AST's to respond to queries that originate from On-line Analytical Processing (“OLAP”). These can involve standard statistical or data-mining methods.

Chen et al. examined the problem of applying OLAP to dynamic rather than static situations. In particular, they were interested in multi-dimensional regression analysis of time-series data streams. They recognized that it should be possible to use only a small number of pre-computed quantities rather than all of the data. However, 25 the algorithms that they propose are very involved and constrained in their utility.

U.S. Pat. No. 6,553,366 shows how great economies of data storage requirements and time can be obtained by storing and using various “scalable data mining functions” computed from a relational database. This is the most recent 30 version of the “automatic summary table” idea.

Thus, although the prior art has recognized that pre-computing quantities needed in subsequent modeling calculations saves time and data storage, the methods developed fail to satisfy some or all of the other requirements mentioned above. Often they can add records but cannot remove records to their “static” databases. Adding new variables or removing variables “on the fly” (in real time) is not generally known. They are not used to combine databases or for parallel processing. Scenario testing is very limited and does not involve dimension reduction. Dynamic query is not done with static decision trees being commonplace. Methods are generally embedded in large office information systems with so many quantities computed and so many ties to existing interfaces that portability is challenging.

It is therefore an object of the present invention to provide a method of and apparatus for data analysis that obviates or mitigates some of the above disadvantages.

### SUMMARY OF THE INVENTION

In one aspect, the present invention provides a “knowledge entity” that may be used to perform incremental learning. The knowledge entity is conveniently represented as a matrix where one dimension represents independent variables and the other dimension represents dependent variables. For each possible pairing of variables, the knowledge entity stores selected combinations of either or both of the variables. These selected combinations are termed the “knowledge elements” of the knowledge entity. This knowledge entity may be updated efficiently with new records by matrix addition. Furthermore, data can be removed from the knowledge entity by matrix subtraction. Variables can be added or removed from the knowledge entity by adding or removing a set of cells, such as a row or column to one or both dimensions.

Preferably the number of joint occurrences of the variables is stored with the selected combinations.

Exemplary combinations of the variables are the sum of values of the first variable for each joint occurrence, the sum of values of the second variable for each joint occurrence, and the sum of the product of the values of each variable.

In one further aspect of the present invention, there is provided a method of performing a data analysis by collecting data in such the knowledge entity and utilising it in a subsequent analysis.

According to another aspect of the present invention, there is provided a process modelling system utilising such the knowledge entity.

According to other aspects of the present invention, there is a provided either a learner or predictor using such the knowledge entity.

The term “analytical engine” is used to describe the knowledge entity together with the methods required to use it to accomplish incremental learning operations, parallel processing operations, scenario testing operations, dimension reduction operations, dynamic query operations and/or distributed processing operations. These methods include but are not limited to methods for data collecting, management of the knowledge elements, modelling and use of the modelling (for prediction for example). Some aspects of the management of the knowledge elements may be delegated to a conventional data management system (simple summations of historical data for example). However, the knowledge entity is a collection of knowledge elements specifically selected so as to enable the knowledge entity to accomplish the desired operations. When modeling is accomplished using the knowledge entity it is referred to as “intelligent modeling” because the resulting model receives one or more characteristics of intelligence. These characteristics include: the ability to immediately utilize new data, to purposefully ignore some data, to incorporate new variables, to not use specific variables and, if necessary, to do be able to utilize these characteristics on-line (at the point of use) and in real time.

### BRIEF DESCRIPTION OF THE DRAWINGS

Embodiments of the invention will now be described by way of example only with reference to the accompanying drawings in which:

FIG. 1 is a schematic diagram of a processing apparatus;

FIG. 2 is a representation of a controller for the processing apparatus of FIG. 1;

FIG. 3 is a schematic of a the knowledge entity used in the controller of FIG. 2;

FIG. 4 is a flow chart of a method performed by the controller of FIG. 2;

FIG. 5 is another flow chart of a method performed by the controller of FIG. 2;

FIG. 6 is a further flow chart of a method performed by the controller of FIG. 2;

FIG. 7 is a yet further flow chart of a method performed by the controller of FIG. 2;

FIG. 8 is a still further flow chart of a method performed by the controller of FIG. 2;

FIG. 9 is a schematic diagram of a robotic arm;

FIG. 10 is a schematic diagram of a Markov chain;

FIG. 11 is a schematic diagram of a Hidden Markov model;

FIG. 12 is another schematic diagram of a Hidden Markov model.

### DESCRIPTION OF THE PREFERRED EMBODIMENTS

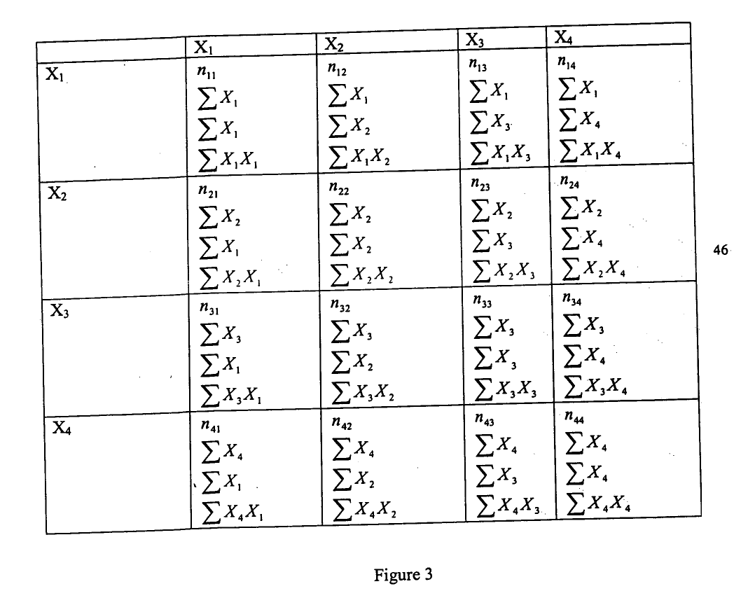

To assist in understanding the concepts embodied in the present invention and to demonstrate the industrial applicability thereof with its inherent technical effect, a first embodiment will describe how the analytical engine enables application to the knowledge entity of incremental learning operations for the purpose of process monitoring and control. It will be appreciated that the form of the processing apparatus is purely for exemplary purposes to assist in the explanation of the use of the knowledge entity shown in FIG. 3, and is not intended to limit the application to the particular apparatus or to process control environments. Subsequent embodiments will likewise illustrate the flexibility and general applicability in other environments.

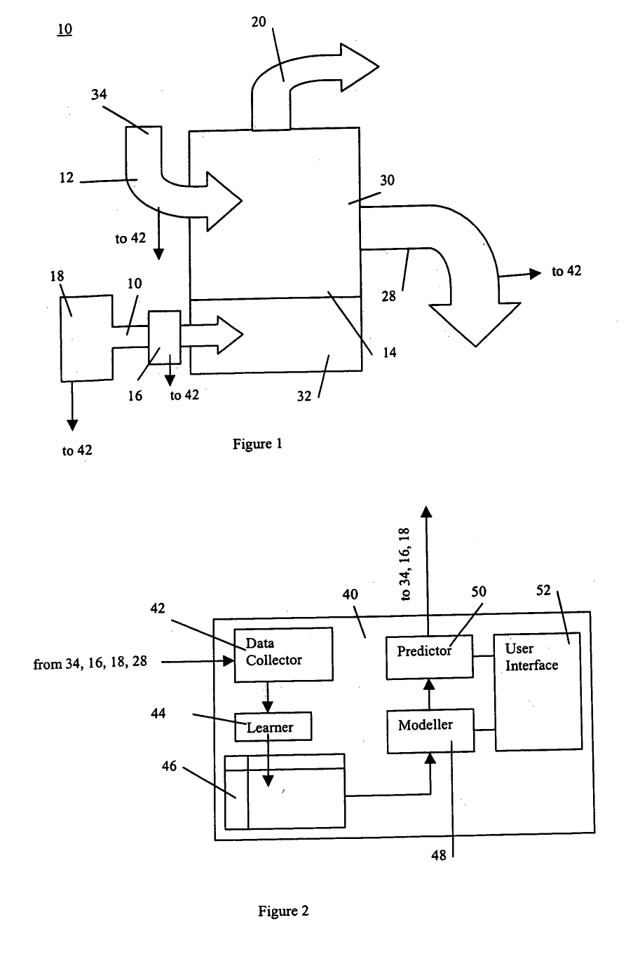

Referring therefore to FIG. 1, a dryer 10 has a feed tube 12 for receiving wet feed 34. The feed tube 12 empties into a main chamber 30. The main chamber 30 has a lower plate 14 to form a plenum 32. An air inlet 18 forces air into a heater 16 to provide hot air to the plenum 32. An outlet tube 28 receives dried material from the main chamber 30. An air outlet 20 exhausts air from the main chamber 32.

The dryer 10 is operated to produce dried material, and it is desirable to control the rate of production. An exemplary operational goal is to produce 100 kg of dried material per hour.

The dryer receives wet feed 34 through the feed tube 12 at an adjustable and observable rate. The flow rate from outlet tube 28 can also be monitored. The flow rate from outlet tube 28 is related to operational parameters such as the wet feed flow rate, the temperature provided by heater 16, and the rate of air flow from air inlet 18. The dryer 10 incorporates a sensor for each operational parameter, with each sensor connected to a controller 40 shown in detail in FIG. 2. The controller 40 has a data collection unit 42, which receives inputs from the sensors associated with the wet feed tube 12, the heater 16, the air inlet 18, and the output tube 28 to collect data.

The controller 40 has a learner 44 that processes the collected data into a knowledge entity 46. The knowledge entity 46 organises the data obtained from the operational parameters and the output flow rate. The knowledge entity 46 is initialised to notionally contain all zeroes before its first use. The controller 40 uses a modeller 48 to form a model of the collected data from the knowledge entity 46. The controller 40 has a predictor 50 that can set the operational parameters to try to achieve the operational goal. Thus, as the controller operates the dryer 10, it can monitor the production and incrementally learn a better model.

The controller 40 operates to adjust the operational parameters to control the rate of production. Initially the dryer 10 is operated with manually set operational parameters. The initial operation will produce training data from the various sensors, including output rate.

The data collector 42 receives signals related to each of the operational parameters and the output rate, namely a measure of the wet feed rate from the wet feed tube 12, a measure of the air temperature from the heater 16, a measure of the air flow from the air inlet 18, and a measure of the output flow rate from the output tube 28.

The learner 44 transforms the collected data into the knowledge entity of FIG. 3 as each measurement is received. As can be seen in FIG. 3, the knowledge entity 46 is organised as an orthogonal matrix having a row and a column for each of the sensed operating parameters. The intersection of each row and column defines a cell in which a set of combinations of the variable in the respective row and column is accumulated.

In the embodiment of FIG. 3, for each pairing of variables, a set of four combinations is obtained. The first combination, n_{i,j} is a count of the number of joint occurrences of the two variables. The combination ΣXᵢ represents the total of all measurements of the first variable Xᵢ, which is one of the sensed operational parameters. The second quantity ΣXⱼ records the total of all measurements of the second variable Xⱼ, which is another of the sensed operational parameters. Finally, ΣXᵢXⱼ records the total of the products of all measurements of both variables. It is noted that the summations are over all observed measurements of the variables.

These combinations are additive, and accordingly can be computed incrementally. For example, given observed measurements [3, 4, 5, 6] for the variable Xᵢ, then ΣXᵢ=3+4+5+6=18. If the measurements are subdivided into two collections of observed measurements [3, 4] and [5, 6], for example from sensors at two different locations, then

$${\sum }_{[ 3 , 4 ]} {X}_{i} = 7 and {\sum }_{[ 5 , 6 ]} {X}_{i} = 11 so {\sum }_{[ 3 , 4 , 5 , 6 ]} {X}_{i} = {\sum }_{[ 3 , 4 ]} {X}_{i} + {\sum }_{[ 5 , 6 ]} {X}_{i} .$$

The nature of the subdivision is not relevant, so the combination can be computed incrementally for successive measurements, and two collections of measurements can be combined by addition of their respective combinations.

In general, the combinations of parameters accumulated should have the property that given a first and second collection of data, the value of the combination of the collections may be efficiently computed from the values of the collections themselves. In other words, the value obtained for a combination of two collections of data may be obtained from operations on the value of the collections rather than on the individual elements of the collections.

It is also recognised that the above combinations have the property that given a collection of data and additional data, which can be combined into an augmented collection of data, the value of the combination for the augmented collection of data is efficiently computable from the value of the combination for the collection of data and the value of the combination for the additional data. This property allows combination of two collections of measurements.

An example of data received by the data collector 42 from the dryer of FIG. 1 in four separate measurements is as follows:

TABLE 1

| | Wet | | | Dry |
|---|---|---|---|---|
| Measurement | Feed Rate | Air Temperature | Air Flow | Output Rate |
| 1 | 10 | 30 | 110 | 2 |
| 2 | 15 | 35 | 115 | 3 |
| 3 | 5 | 40 | 120 | 1.5 |
| 4 | 15 | 50 | 140 | 6 |

With the measurements shown above in Table 1, measurement 1 is transformed into the following record represented as an orthogonal matrix:

TABLE 2

| | Wet | Air | | Dry |
|---|---|---|---|---|
| Measurement 1 | Feed Rate | Temperature | Air Flow | Output Rate |
| Wet Feed Rate | 1 = n₁₁ | 1 | 1 | 1 |
| | 10 = x₁ | 10 | 10 | 10 |
| | 10 = x₂ | 30 | 110 | 2 |
| | 100 = x₁x₂ | 300 | 1100 | 20 |
| Air Temperature | 1 | 1 | 1 | 1 |
| | 30 | 30 | 30 | 30 |
| | 10 | 30 | 110 | 2 |
| | 300 | 900 | 3300 | 60 |
| Air Flow | 1 | 11 | 1 | 1 |
| | 110 | 110 | 110 | 110 |
| | 10 | 30 | 110 | 2 |
| | 1100 | 3300 | 12100 | 220 |
| Dry Output Rate | 1 | 1 | 1 | 1 |
| | 2 | 2 | 2 | 2 |
| | 10 | 30 | 110 | 2 |
| | 20 | 60 | 220 | 4 |

This measurement is added to the knowledge entity 46 by the learner 42. Each subsequent measurement is transformed into a similar table and added to the knowledge entity 46 by the learner 42.

For example, upon receipt of the second measurement, the cell at the intersection of the wet feed row and air temperature column would be updated to contain:

TABLE 3

| | Air Temperature |
|---|---|
| Wet Feed Rate | 1 + 1 = 2 |
| | 10 + 15 = 25 |
| | 30 + 35 = 65 |
| | 300 + 525 = 825 |

Successive measurements can be added incrementally to the knowledge entity 46 since the knowledge entity for a new set of data is equal to the sum of the knowledge entity for an old set data with the knowledge entity of the additional data. Each of the combinations F used in the knowledge entity 46 have the exemplary property that F(A∪B)=F(A)+F(B) for sets A and B. Further properties of the knowledge entity 46 will be discussed in more detail below.

As data are collected, the controller 40 accumulates data in the knowledge entity 46 which may be used for modelling and prediction. The modeller 48 determines the parameters of a predetermined model based on the knowledge entity 46. The predictor 50 can then use the model parameters to determine desirable settings for the operational parameters.

After the controller 40 has been trained, it can begin to control the dryer 10 using the predictor 50. Suppose that the operator instructs the controller 40 through the user interface 52 to set the production rate to 100 kg/h by varying the air temperature at heater 16, and that the appropriate control method uses a linear regression model.

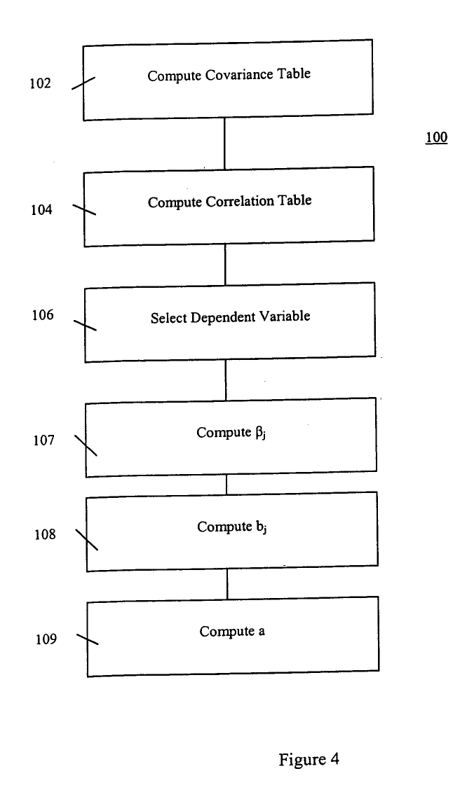

The modeller 48 computes regression coefficients as shown in FIG. 4 generally by the numeral 100. At step 102, the modeller computes a covariance table. Covariance between two variables Xᵢ and Xⱼ may be computed as

$${Covar}_{i , j} = \frac{\sum {X}_{i} {X}_{j} - \frac{\sum {X}_{i} \sum {X}_{j}}{{n}_{ij}}}{{n}_{ij}} .$$

Since each of these terms is one of the combinations stored in the knowledge entity 46 at the intersection of row i and column j, computation of the covariance for each pair of variables is done with two divisions and one subtraction. When i=j, the covariance is equal to the variance, i.e. Covar_{i,j}=Varᵢ=Varⱼ. The modeller 48 uses this relationship to compute the covariance between each pair of variables.

Then at step 104, the modeller 48 computes a correlation table. The correlation between two variables Xᵢ and Xⱼ may be computed as

$${R}_{i , j} = \frac{{Covar}_{i , j}}{\sqrt{{Var}_{i} {Var}_{j}}} .$$

Since each of 10 these terms appears in the covariance table obtained from the knowledge entity 46 at step 102, the correlation coefficient can be computed with one multiplication, one square root, and one division. The modeller 48 uses this relationship to compute the correlation between each pair of variables.

At step 106, the operator selects a variable Y, for example X₄, to model through the user interface 52. At step 107, the modeller 48 computes β=R_{i,j}⁻¹R_{y,j} using the entries in the correlation table.

At step 108, the modeller 48 first computes the standard deviation s_{y} of the dependent variable Y and the standard deviation sⱼ of independent variables Xⱼ. Conveniently, the standard deviations s_{y}=\sqrt{Var_{y}} and sⱼ=\sqrt{Varⱼ} are computed using the entries from the covariance table. The modeller 48 then computes the coefficients

$${b}_{j} = {β}_{j} ( \frac{{s}_{y}}{{s}_{j}} ) .$$

At step 109, the modeller 48 computes an intercept a=\overline{X₄}−b₁\overline{X₁}−b₂\overline{X₂}−b₃\overline{X₃}. The modeller 48 then provides the coefficients a, b₁, b₂, b₃ to the predictor 50.

The predictor 50 can then estimate the dependent variable as Y=a+b₁\overline{X₁}+b₂\overline{X₂}+b₃\overline{X₃}.

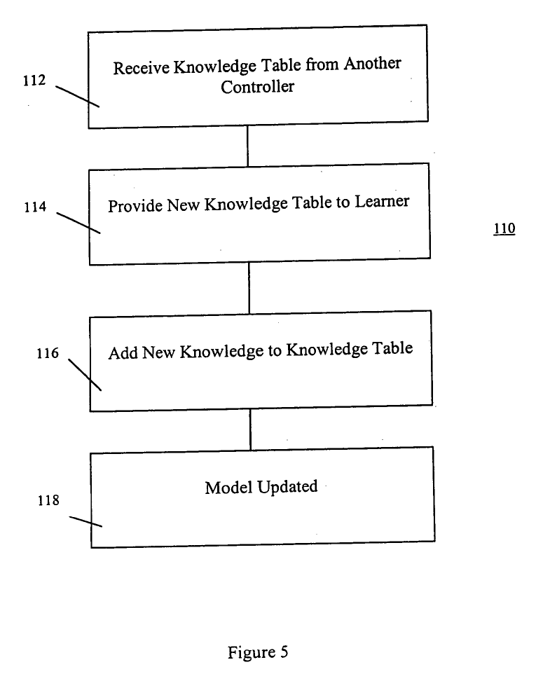

The knowledge entity shown in FIG. 3 provides the analytical engine ignificant flexibility in handling varying collections of data. Referring to FIG. 5 a ethod of amalgamating knowledge from another controller is shown generally by he numeral 110. The controller 40 first receives at step 112 a new knowledge entity rom another controller. The new knowledge entity is organised to be of the same form as the existing knowledge entity 46. This new knowledge entity may be based upon a similar process in another factory, or another controller in the same factory, or even standard test data or historical data. The controller 40 provides at step 114 the new knowledge entity to learner 44. Learner 44 adds the new knowledge to the knowledge entity 46 at step 116. The new knowledge is added by performing a matrix addition (i.e. addition of similar terms) between the knowledge entity 46 and the new knowledge entity. Once the knowledge entity 46 has been updated, the model is updated at step 118 by the modeller 48 based on the updated knowledge entity 46

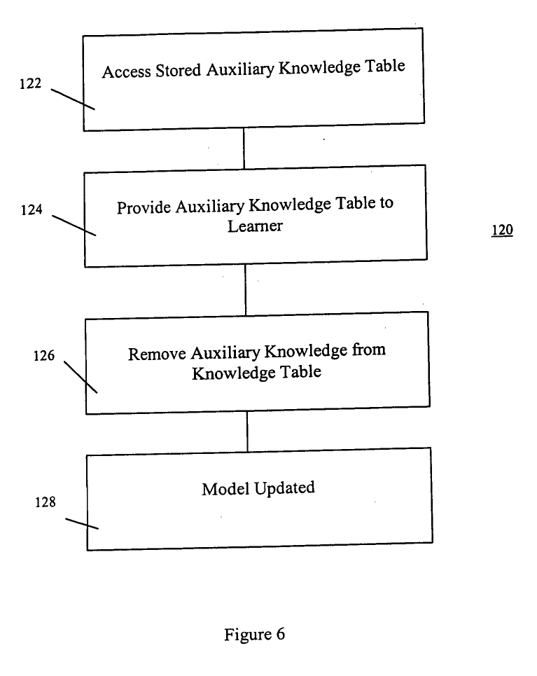

In some situations it may be necessary to reverse the effects of amalgamating knowledge shown in FIG. 5. In this case, the method of FIG. 6 may be used to remove knowledge. Referring therefore to FIG. 6, a method of removing knowledge from the knowledge entity 46 is shown generally by the numeral 120. To begin, at step 122, the controller 40 accesses a stored auxiliary knowledge entity. This may be a record of previously added knowledge from the method of FIG. 5. Alternatively, this may be a record of the knowledge entity at a specific time. For example, it may be desirable to eliminate the knowledge added during the first hour of operations, as it may relate to startup conditions in the plant which are considered irrelevant to future modelling. The stored auxiliary knowledge entity has the same form as the knowledge entity 46 shown in FIG. 3. The controller 40 provides the auxiliary knowledge entity to the learner 44 at step 124. The learner 44 at step 126 then removes the auxiliary knowledge from the knowledge entity 46 by subtracting the auxiliary knowledge entity from knowledge entity 46. Finally at step 128, the model is updated with the modified knowledge entity 46.

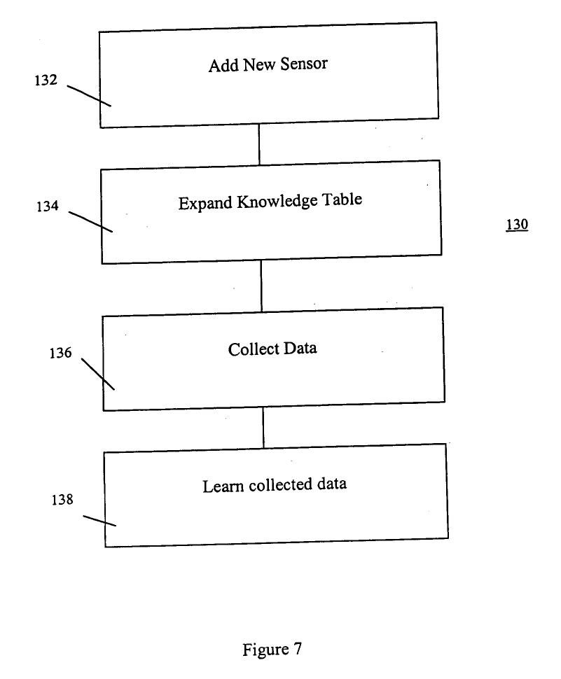

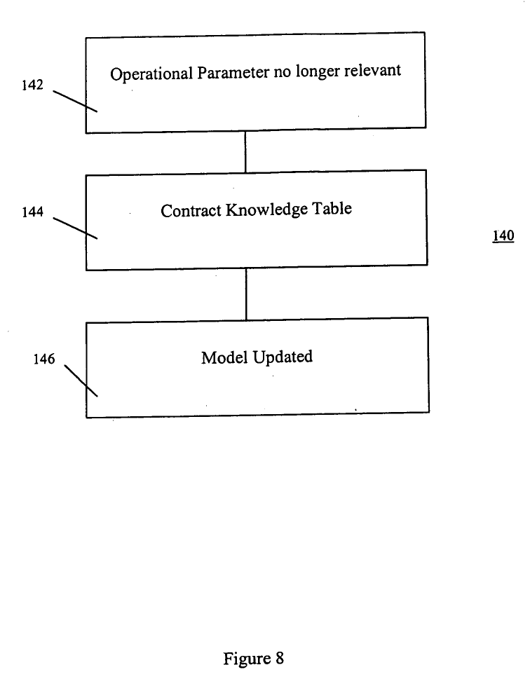

To further refine the modelling, an additional sensor may be added to the dryer 10. For example, a sensor to detect humidity in the air inlet may be used to consider the effects of external humidity on the system. In this case, the model may be updated by performing the method shown generally by the numeral 130 in FIG. 7. First a new sensor is added at step 132. The learner 44 then expands the knowledge entity by adding a row and a column. The combinations in the new row and the new column have notional values of zero. The controller 44 then proceeds to collect data at step 136. The collected data will include that obtained from the old sensors and that of the new sensor. This information is learned at step 138 in the same manner as before. The knowledge entity 46 in the analytical engine can then be used with the new sensor to obtain the coefficients of the linear regression using all the sensors including the new sensor. It will be appreciated that since the values of ‘n’ in the new row and column initially are zero, that there will be a significant difference between the values of ‘n’ in the new row and column and in the old rows and columns. This difference reflects that more data has been collected for the original rows and columns. It will therefore be recognised that provision of the value of ‘n’ contributes to the flexibility of the knowledge entity.

It may also be desirable to eliminate a sensor from the model. For example, it may be discovered that air flow does not affect the output speed, or that air flow may be too expensive to measure. The method shown generally as 140 in FIG. 7 allows an operational parameter to be removed from the knowledge entity 46. At step 142, an operational parameter is no longer relevant. The operational parameter corresponds to a variable in the knowledge entity 46. The learner 44 then contracts the knowledge entity at step 144 by deleting the row and column corresponding to the removed variable. The model is then updated at step 146 to obtain the linear regression coefficients for the remaining variable to eliminate use of the deleted variable.

It will be noted in each of these examples that the updates is accomplished without requiring a summing operation for individual values of each of the previous records. Similarly subtraction is performed without requiring a new summing operation for the remaining records. No substantial re-training or re-calibration is required.

### Distributed and Parallel Data Processing

A particularly useful attribute of the knowledge entity 46 in the analytical engine is that it allows databases to be divided up into groups of records with each group processed separately, possibly in separate computers. After processing, the results from each of these computers may be combined to achieve the same result as though the whole data set had been processed all at once in one computer. The analytical engine is constructed so as to enable application to the knowledge entity of such parallel processing operations. This can achieve great economies of hardware and time resources. Furthermore, instead of being all from the one database, some of these groups of records can originate from other databases. That is, they may be “distributed” databases. The combination of diverse databases to form a single knowledge entity and hence models which draw upon all of these databases is then enabled. That is, the analytical engine enables application to the knowledge entity of distributed processing as well as parallel processing operations.

As an illustration, if the large database (or distributed databases) can be divided into ten parts then these parts may be processed on computers 1 to 10 inclusive, for example. In this case, these computers each process the data and construct a separate knowledge entity. The processing time on each of these computers depends on the number of records in each subset but the time required by an eleventh computer to combine the records by processing the knowledge entity is small (usually a few milliseconds). For example, with a dataset with 1 billion records that normally requires 10 hours to process in a single computer, the processing time can be decreased to 1 hour and a few seconds by subdividing the dataset into ten parts.

To demonstrate this attribute, the following example considers a very small dataset of six records and an example of interpretation of dryer output rate data from three dryers. If, for example, the output rate from the third dryer is to be predicted from the output rate from the other two dryers then an equation is required relating it to these other two output rates. The data is shown in the table below where X₁, X₂ and X₃ represent the three output rates. The sample dataset with six records and three variables is set forth below at Table 4.

TABLE 4

| X₁ | X₂ | X₃ |
|---|---|---|
| 2 | 3 | 5 |
| 3 | 4 | 7 |
| 1 | 1 | 3 |
| 2 | 3 | 6 |
| 4 | 4 | 8 |
| 3 | 5 | 7 |

With such a small amount of data it is practical to use multiple linear regression to obtain the needed relationship:

Multiple linear regression for the dataset shown in Table 4 provides the relationship:

X₃=1.652+1.174*X₁+0.424*X₂

However, if this dataset consisted of a billion records instead of only six then multiple linear regression on the whole dataset at once would not be practical. The conventional approach would be to take only a random sample of the data and obtain a multiple linear regression model from that, hoping that the resulting model would represent the entire dataset.

Using the knowledge entity 46, the analytical engine can use the entire dataset for the regression model, regardless of the size of the data set. This can be illustrated using only the six records shown as follows and dividing the dataset into only three groups.

Step 1: Divide the dataset to three subsets with two records in each, and complete a knowledge entity for each subset. The data in subset 1 has the form shown below in Table 5.

Subset 1:

TABLE 5

| X₁ | X₂ | X₃ |
|---|---|---|
| 2 | 3 | 5 |
| 3 | 4 | 7 |

From the data in Table 5 above, a knowledge entity I (Table 6) is calculated for subset 1

(Table 5) using a first computer.

TABLE 6

| | X₁ | X₂ | X₃ |
|---|---|---|---|
| X₁ | 2 | 2 | 2 |
| | 5 | 5 | 5 |
| | 5 | 7 | 12 |
| | 13 | 18 | 31 |
| X₂ | 2 | 2 | 2 |
| | 7 | 7 | 7 |
| | 5 | 7 | 12 |
| | 18 | 25 | 43 |
| X₃ | 2 | 2 | 2 |
| | 12 | 12 | 12 |
| | 5 | 7 | 12 |
| | 31 | 43 | 74 |

As described above, the knowledge entity 46 is built by using the basic units which includes an input variable Xⱼ an output variable Xᵢ and a set of combinations indicated as Wᵢⱼ, as shown in Table 7:

TABLE 7

| | Xⱼ |
|---|---|
| Xᵢ | Wᵢⱼ |

Where Wᵢⱼ includes one or more of the following four basic elements:

Nᵢⱼ is the total number of joint occurrence of two variables

□Xᵢ is the sum of variable Xᵢ

□Xⱼ is the sum of variable Xⱼ

□XᵢXⱼ is the sum of multiplication of variable Xᵢ and Xⱼ

In some applications it may be advantageous to include additional knowledge elements for specific calculation reasons. For example: □X³, □X⁴ and □(XᵢXⱼ)² can generally be included in the knowledge entity in addition to the four basic elements mentioned above without adversely affecting the intelligent modeling capabilities.

The data in subset 2 has the form shown below in Table 8.

Subset 2:

TABLE 8

| X₁ | X₂ | X₃ |
|---|---|---|
| 1 | 1 | 3 |
| 2 | 3 | 6 |

A knowledge entity II (Table 9) is calculated for subset 2 (Table 8) using a second computer.

TABLE 9

| | X₁ | X₂ | X₃ |
|---|---|---|---|
| X₁ | 2 | 2 | 2 |
| | 3 | 3 | 3 |
| | 3 | 4 | 9 |
| | 5 | 7 | 15 |
| X₂ | 2 | 2 | 2 |
| | 4 | 4 | 4 |
| | 3 | 4 | 9 |
| | 7 | 10 | 21 |
| X₃ | 2 | 2 | 2 |
| | 9 | 9 | 9 |
| | 3 | 4 | 9 |
| | 15 | 21 | 45 |

Similarly, for subset 3 shown in Table 10, a knowledge entity III (Table 11) is computed using a third computer.

Subset 3:

TABLE 10

| X₁ | X₂ | X₃ |
|---|---|---|
| 4 | 4 | 8 |
| 3 | 5 | 7 |

TABLE 11

| | X₁ | X₂ | X₃ |
|---|---|---|---|
| X₁ | 2 | 2 | 2 |
| | 7 | 7 | 7 |
| | 7 | 9 | 15 |
| | 25 | 31 | 53 |
| X₂ | 2 | 2 | 2 |
| | 9 | 9 | 9 |
| | 7 | 9 | 15 |
| | 31 | 41 | 67 |
| X₃ | 2 | 2 | 2 |
| | 15 | 15 | 15 |
| | 7 | 9 | 15 |
| | 53 | 67 | 113 |

Step 2: Calculate a knowledge entity IV (Table 12) by adding together the three previously calculated knowledge tables using a fourth computer.

TABLE 12

| | X₁ | X₂ | X₃ |
|---|---|---|---|
| X₁ | 6 | 6 | 6 |
| | 15 | 15 | 15 |
| | 15 | 20 | 36 |
| | 43 | 56 | 99 |
| X₂ | 6 | 6 | 6 |
| | 20 | 20 | 20 |
| | 15 | 20 | 36 |
| | 56 | 76 | 131 |
| X₃ | 6 | 6 | 6 |
| | 36 | 36 | 36 |
| | 15 | 20 | 36 |
| | 99 | 131 | 232 |

Step 3: Calculate the covariance matrix from knowledge entity 4 using the following equation. If i=j the covariance is the variance. Each of the terms used in the covariance matrix are available from the composite knowledge entity shown in Table 12.

TABLE 13

| | X_{J} |
|---|---|
| Xᵢ | ${Covar}_{ij} = \frac{\sum {X}_{i} {X}_{j} - \frac{( \sum {X}_{i} \sum {X}_{j} )}{{N}_{ij}}}{{N}_{ij}}$ |

The resulting covariance matrix from Table 12 is set out below at Table 14.

TABLE 14

| | X₁ | X₂ | X₃ |
|---|---|---|---|
| X₁ | 0.916666667 | 1 | 1.5 |
| X₂ | 1 | 1.555555556 | 1.833333333 |
| X₃ | 1.5 | 1.833333333 | 2.666666667 |

Step 4: Calculate the correlation matrix from the covariance matrix using the following equation.

TABLE 15

| | X_{J} |
|---|---|
| Xᵢ | $\begin{matrix}{R}_{ij} = \frac{{Covar}_{ij}}{\sqrt{{Var}_{i} {Var}_{j}}} \\ where \text{:} \\ {Var}_{i} = {Covar}_{ii} \\ {Var}_{j} = {Covar}_{jj}\end{matrix}$ |

Correlation matrix:

TABLE 16

| | X₁ | X₂ | X₃ |
|---|---|---|---|
| X₁ | 1 | 0.837435789 | 0.959403224 |
| X₂ | 0.837435789 | 1 | 0.900148797 |
| X₃ | 0.959403224 | 0.900148797 | 1 |

Step 5: Select the dependent variable y (X₃) and then slice the correlation matrix to a matrix for the independent variables Rᵢⱼ and a vector for the dependent variable R_{yj}. Calculate the population coefficient βⱼ for independent variables Xⱼ using the relationship.

□ⱼ=R⁻¹ᵢⱼR_{yj}

From Table 16, a dependent variable correlation vector R_{yj} is obtained as shown in Table 17.

TABLE 17
X₃
0.959403224
0.900148797

Similarly, the independent variables correlation matrix Rᵢⱼ and its inverse matrix Rᵢⱼ⁻¹ for X₁ and X₂ is obtained from Table 16 as set forth below at Tables 18 and 19 respectively.

TABLE 18

| | X₁ | X₂ |
|---|---|---|
| X₁ | 1 | 0.837435789 |
| X₂ | 0.837435789 | 1 |

TABLE 19

| | X₁ | X₂ |
|---|---|---|
| X₁ | 3.347826087 | −2.803589382 |
| X₂ | −2.803589382 | 3.347826087 |

Calculate □ vector for Table 17 and 19 to obtain:

TABLE 20
□
0.68826753
0.32376893

Step 6: Calculate sample coefficients bⱼ

bⱼ=□ⱼ(s_{y}/sⱼ)

s_{y} is the sample standard deviation of dependent variable X₃ and sⱼ the sample standard deviation of independent variables (X₁, X₂) which can be easily calculated from the knowledge entity 46.

b₁=0.68826753*(1.788854382*1.048808848)=1.173913043=1.174

b₂=0.32376893*(1.788854382*1.366260102)=0.423913043=0.424

Step 7: Calculate intercept a from the following equation (Y is X₃ in our example):

a=\overline{Y}−b₁\overline{X}₁−b₂\overline{X}₂− . . . −bₙ\overline{X}ₙ

where any mean value can be calculated from □Xᵢ/Nᵢᵢ

a=6−(1.174*2.5)−(0.424*3.3333)=1.652173913=1.652

Step 8: Finally the linear equation which can be used for the prediction.

X₃=1.652+1.174*X₁+0.424*X₂

which will be recognised as the same equation calculated from whole dataset.

The above examples have used a linear regression model. Using the knowledge entity 46, the analytical engine can also develop intelligent versions of other models, including, but not limited to, non-linear regression, linear classification, on-linear classification, robust Bayesian classification, naïve Bayesian classification, Markov chains, hidden Markov models, principal component analysis, principal component regression, partial least squares, and decision tree.

An example of each of these will be provided, utilising the data obtained from the process of FIG. 1. Again, it will be recognised that this procedure is not process dependent but may be used with any set of data.

### Linear Classification

As mentioned above, effective scenario testing depends upon being able to examine a wide variety of mathematical models to see future possibilities and assess relationships amongst variables while examining how well the existing data is explained and how well new results can be predicted. The analytical engine enables provides an extremely effective method for accomplishing scenario testing. One important attribute is that it enables many different modeling methods to be examined including some that involve qualitative (categorical) as well as quantitative (numerical) quantities. Classification is used when the output (dependent) variable is a categorical variable. Categorical variables can take on distinct values, such as colours (red, green, blue) or sizes (small, medium, large). In the embodiment of the dryer 10, a filter may be provided in the vent 20, and optionally removed. A categorical variable for the filter has possible values “on” and “off” reflective of the status of the filter. Suppose the dependent variable Xᵢ has k values. Instead of just one regression model we build k models by using the same steps as set out above with reference to a model using linear regression.

Xᵢ₁=a₁+b₁₁X₁+b₂₁X₂+ . . . +bₙ₁Xₙ

Xᵢ₂=a₂+b₁₂X₁+b₂₂X₂+ . . . +bₙ₂Xₙ . . .

Xᵢₖ=aₖ+b₁ₖX₁+b₂ₖX₂+ . . . +bₙₖXₙ

In the prediction phase, each of the models for Xᵢ₁, . . . , Xᵢₖ is used to construct an estimate corresponding to each of the k possible values. The k models compete with each other and the model with the highest value will be the winner, and determines the predicted one of the k possible values. Using the following equation will transform the actual value to probability.

P(Xᵢₖ)=1/(1+exp(−Xᵢₖ))

Suppose we have a model with two variables (X₁, X₂) and X₂ is a categorical variable with values (A, B). In the example of the dryer, A corresponds to the filter being on, and B corresponds to the filter being off. The knowledge entity 46 for this model is going to have one column/row for any categorical value (X_{2A}, X_{2B})

X_{2A}=a_{A}+b_{1B}X₁

X_{2B}=a_{B}+b_{1B}X₁

Table 21 shows a knowledge entity 46 with a categorical variable X₂.

TABLE 21

| | |
|---|---|
| X₁ | X₂ |

| | | X₁ | X_{2A} | X_{2B} |
|---|---|---|---|---|
| X₁ | X₁ | N₁₁ | N_{12A} | N_{12B} |
| | | □ X₁ | □ X₁ | □ X₁ |
| | | □ X₁ | □ X_{2A} | □ X_{2B} |
| | | □ X₁ X₁ | □ X₁ X_{2A} | □ X₁ X_{2B} |
| X₂ | X_{2A} | N_{2A1} | N_{2A2A} | N_{2A2B} |
| | | □ X_{2A} | □ X_{2A} | □ X_{2A} |
| | | □ X₁ | □ X_{2A} | □ X_{2B} |
| | | □ X_{2A} X₁ | □ X_{2A} X_{2A} | □ X_{2A} X_{2B} |
| | X_{2B} | N_{2B1} | N_{2B2A} | N_{2B2B} |
| | | □ X_{2B} | □ X_{2B} | □ X_{2B} |
| | | □ X₁ | □ X_{2A} | □ X_{2B} |
| | | □ X_{2B} X₁ | □ X_{2B} X_{2A} | □ X_{2B} X_{2B} |

Table 22 shows a knowledge entity 46 for X_{2A}

TABLE 22

| | | X₁ | X₂ |
|---|---|---|---|
| | | X₁ | X_{2A} |
| X₁ | X₁ | N₁₁ | N_{12A} |
| | | □ X₁ | □ X₁ |
| | | □ X₁ | □ X_{2A} |
| | | □ X₁ X₁ | □ X₁ X_{2A} |
| X₂ | X_{2A} | N_{2A1} | N_{2A2A} |
| | | □ X_{2A} | □ X_{2A} |
| | | □ X₁ | □ X_{2A} |
| | | □ X_{2A} X₁ | □ X_{2A} X_{2A} |

Table 23 shows a knowledge entity 46 for X_{2B}

TABLE 23

| | | X₁ | X₂ |
|---|---|---|---|
| | | X₁ | X_{2B} |
| X₁ | X₁ | N₁₁ | N_{12B} |
| | | □ X₁ | □ X₁ |
| | | □ X₁ | □ X_{2B} |
| | | □ X₁X₁ | □ X₁X_{2B} |
| X₂ | X_{2B} | N_{2B1} | N_{2B2B} |
| | | □ X_{2B} | □ X_{2B} |
| | | □ X₁ | □ X_{2B} |
| | | □ X_{2B}X₁ | □ X_{2B}X_{2B} |

The knowledge entity 46 shown in Tables 22 and 23 may then be applied to model each value of the categorical variable X₂. Prediction of the categorical variable is then performed by predicting a score for each possible value. The possible value with the highest score is chosen as the value of the categorical variable. The analytical engine thus enables the development of models which involve categorical as well as numerical variables

### Non-Linear Regression and Classification

The analytical engine is not limited to the generation of linear mathematical models. If the appropriate model is non-linear, then the knowledge entity shown in FIG. 3 is also used. The combinations used in the table are sufficient to compute the non-linear regression.

The method of FIG. 7 showed how to expand the knowledge entity 46 to include additional variables. This feature also allows the construction of non-linear regression or classification models. It is noted that non-linearity is about variables not coefficients. Suppose we have a linear model with two variables (X₁, X₂) but we believe Log (X₁) could give us a better result. The only thing we need to do is to follow the three steps for adding a new variable. Log (X₁) will be the third variable in the knowledge entity 46 and a regression model can be constructed in the explained steps. If we do not need X₁ anymore it can be removed by using the contraction feature described above.

TABLE 24

| | X₁ | X₂ | X₃ = Log (X₁) |
|---|---|---|---|
| X₁ | N₁₁ | N₁₂ | N₁₃ |
| | □ X₁ | □ X₁ | □ X₁ |
| | □ X₁ | □ X₂ | □ X₃ |
| | □ X₁X₁ | □ X₁X₂ | □ X₁X₃ |
| X₂ | N₂₁ | N₂₂ | N₂₃ |
| | □ X₂ | □ X₂ | □ X₂ |
| | □ X₁ | □ X₂ | □ X₃ |
| | □ X₂X₁ | □ X₂X₂ | □ X₂X₃ |
| X₃ | N₃₁ | N₃₂ | N₃₃ |
| | □ X₃ | □ X₃ | □ X₃ |
| | □ X₁ | □ X₂ | □ X₃ |
| | □ X₃X₁ | □ X₃X₂ | □ X₃X₃ |

Once the knowledge entity 46 has been constructed, the learner 44 can acquire data as shown in FIG. 7. The new variable X₃ notionally represents a new sensor which measures the logarithm of X₁. However, values of the new variable X₃ may be computed from values of X₁ by a processor rather than by a special sensor. Regardless of how the values are obtained, the learner 44 builds the knowledge entity 46. Then the modeller 48 determines a linear regression of the three variables X₁, X₂, X₃, where X₃ is a non-linear function of X₁. It will therefore be recognised that operation of the controller 40 is similar for the non-linear regression when the variables are regarded as X₁, X₂, and X₃. The predictor 50 can use a model such as X₂=a+b₁X₁+b₃ X₃ to predict variables such as X₂.

### Dimension Reduction

As stated earlier, reducing the number of variables in a model is termed “dimension reduction”. Dimension reduction can be done by deleting a variable. As shown earlier, using the knowledge entity the analytical engine easily accommodates this without using the whole database and a tedious re-calibration or re-training step. Such dimension reduction can also be done by the analytical engine using the sum of two variables or the difference between two variables as a new variable. Again, the knowledge entity permits this step to be done expeditiously and makes extremely comprehensive testing of different combinations of variable practical, even with very large data sets. Suppose we have a knowledge entity with three variables but we want to decrease the dimension by adding two variables (X₁, X₂). For example, the knowledge elements in the knowledge entity associated with the new variable X₄ which is the sum of two other variables, X₁ and X₂ are calculated as follows:

TABLE 25

| | |
|---|---|
| (1) | ${X}_{4} = {X}_{1} + {X}_{2}$ |
| (2) | $\begin{matrix}\sum {X}_{4} = \sum ( {X}_{1} + {X}_{2} ) \\ = \sum {X}_{1} + \sum {X}_{2}\end{matrix}$ |
| (3) | $\begin{matrix}\sum {X}_{4} {X}_{3} = \sum ( {X}_{1} + {X}_{2} ) {X}_{3} \\ = \sum {X}_{1} {X}_{3} + \sum {X}_{2} {X}_{3}\end{matrix}$ |
| (4) | $\begin{matrix}\sum {X}_{4} {X}_{4} = \sum ( {X}_{1} + {X}_{2} ) ( {X}_{1} + {X}_{2} ) \\ = \sum {X}_{1} {X}_{1} + 2 \sum {X}_{1} {X}_{2} + \sum {X}_{2} {X}_{2}\end{matrix}$ |

This is a recursive process and can decrease a model with N dimensions to just to one dimension if it is needed. That is, a new variable X₅ can be defined as the sum of X₄ and X₃.

Alternatively, if we decide to accomplish the dimension reduction by subtracting the two variables, then the relevant knowledge elements for the new variable X₄ are:

TABLE 26

| | |
|---|---|
| (1) | ${X}_{4} = {X}_{1} - {X}_{2}$ |
| (2) | $\begin{matrix}\sum {X}_{4} = \sum ( {X}_{1} - {X}_{2} ) \\ = \sum {X}_{1} - \sum {X}_{2}\end{matrix}$ |
| (3) | $\begin{matrix}\sum {X}_{4} {X}_{3} = \sum ( {X}_{1} - {X}_{2} ) {X}_{3} \\ = \sum {X}_{1} {X}_{3} - \sum {X}_{2} {X}_{3}\end{matrix}$ |
| (4) | $\begin{matrix}\sum {X}_{4} {X}_{4} = \sum ( {X}_{1} - {X}_{2} ) ( {X}_{1} - {X}_{2} ) \\ = \sum {X}_{1} {X}_{1} - 2 \sum {X}_{1} {X}_{2} + \sum {X}_{2} {X}_{2}\end{matrix}$ |

The knowledge elements in the above tables can all be obtained from the knowledge elements in the original knowledge entity obtained from the original data set. That is, the knowledge entity computed for the models without dimension reduction provides the information needed for construction of the knowledge entity of the dimension reduced models.

Now, returning to the example of Table 4 showing the output rates for three different dryers the knowledge entity for the sample dataset is:

TABLE 27

| | X₁ | X₂ | X₃ |
|---|---|---|---|
| X₁ | N₁₁ = 6 | N₁₂ = 6 | N₁₃ = 6 |
| | □ X₁ = 15 | □ X₁ = 15 | □ X₁ = 15 |
| | □ X₁ = 15 | □ X₂ = 20 | □ X₃ = 36 |
| | □ X₁X₁ = 43 | □ X₁X₂ = 56 | □ X₁X₃ = 99 |
| X₂ | N₂₁ = 6 | N₂₂ = 6 | N₂₃ = 6 |
| | □ X₂ = 20 | □ X₂ = 20 | □ X₂ = 20 |
| | □ X₁ = 15 | □ X₁ = 20 | □ X₃ = 36 |
| | □ X₂X₁ = 56 | □ X₂X₂ = 76 | □ X₂X₃ = 131 |
| X₃ | N₃₁ = 6 | N₃₂ = 6 | N₃₃ = 6 |
| | □ X₃ = 36 | □ X₃ = 36 | □ X₃ = 36 |
| | □ X₁ = 15 | □ X₂ = 20 | □ X₃ = 36 |
| | □ X₃X₁ = 99 | □ X₃X₂ = 131 | □ X₃X₃ = 232 |

Table 27 as the same quantities as did Table 12. Table 12 was calculated by combining the knowledge entities from data obtained from dividing the original data set into three portions (to illustrate distributed processing and parallel processing). The above knowledge entity was calculated from the original undivided dataset.

Now, to show dimension reduction can be accomplished by means other than removal of a variable, the data set for variables X₄ and X₃ (where X₄=X₁+X₂) is:

TABLE 28

| X₄ = X₁ + X₂ | X₃ |
|---|---|
| 5 | 5 |
| 7 | 7 |
| 2 | 3 |
| 5 | 6 |
| 8 | 8 |
| 8 | 7 |

The knowledge entity for the X₄, X₃ data set above is:

TABLE 29

| | X₄ | X₃ |
|---|---|---|
| X₄ | N₄₄ = 6 | N₄₃ = 6 |
| | □ X₄ = 35 | □ X₄ = 35 |
| | □ X₄ = 35 | □ X₃ = 36 |
| | □ X₄X₄ = 231 | □ X₄X₃ = 230 |
| | N₃₄ = 6 | N₃₃ = 6 |
| X₃ | □ X₃ = 36 | □ X₃ = 36 |
| | □ X₄ = 35 | □ X₃ = 36 |
| | □ X₃X₄ = 230 | □ X₃X₃ = 232 |

Note that exactly the same knowledge entity can be obtained from the knowledge entity for all three variables and the use of the expressions in Table 25 above.

TABLE 30

| | X₄ | X₃ |
|---|---|---|
| X₄ | N₄₄ = 6 | N₄₃ = 6 |
| | □ X₄ = 15 + 20 = 35 | □ X₄ = 15 + 20 = 35 |
| | □ X₄ = 15 + 20 = 35 | □ X₃ = 36 |
| | □ X₄X₄ = 43 + (2 * 56) + 76 = 231 | □ X₄X₃ = 99 + 131 = 230 |
| X₃ | N₃₄ = 6 | N₃₃ = 6 |
| | □ X₃ = 36 | □ X₃ = 36 |
| | □ X₄ = 15 + 20 = 35 | □ X₃ = 36 |
| | □ X₃X₄ = 99 + 131 = 230 | □ X₃X₃ = 232 |

### Dynamic Queries

The analytical engine can also enable “dynamic queries” to select one or more sequences of a series of questions based on answers given to the questions so as to rapidly converge on one or more outcomes. The Analytical Engine can be used with different models to derive the “next best question” in the dynamic query. Two of the most important are regression models and classification models. For example, regression models can be used by obtaining the correlation matrix from the knowledge entity

The Correlation Matrix:

Then, the following steps are carried out:

Step 1: Calculate the covariance matrix. (Note: if i=j the covariance is the variance.)

TABLE 31

| | X₁ | . . . | Xⱼ | . . . | Xₙ |
|---|---|---|---|---|---|
| X₁ | r₁₁ | . . . | r₁ⱼ | . . . | r₁ₙ |
| . . . | . . . | . . . | . . . | . . . | . . . |
| Xᵢ | rᵢ₁ | . . . | rᵢⱼ | . . . | rᵢₙ |
| . . . | . . . | . . . | . . . | . . . | . . . |
| Xₘ | rₘ₁ | . . . | rₘⱼ | . . . | rₘₙ |

TABLE 32

| | X_{J} |
|---|---|
| Xᵢ | ${Covar}_{ij} = \frac{\sum {X}_{i} {X}_{j} - \frac{\sum {X}_{i} \sum {X}_{j}}{{N}_{ij}}}{{N}_{ij}}$ |

Step 2: Calculate the correlation matrix from the covariance matrix. (Note: if i=j the elements of the matrix are unity.)

TABLE 33

| | X_{J} |
|---|---|
| Xᵢ | $\begin{matrix}{r}_{ij} = \frac{{Covar}_{ij}}{\sqrt{{Var}_{i} \times {Var}_{j}}} \\ where \text{:} \\ {Var}_{i} = {Covar}_{ii} \\ {Var}_{j} = {Covar}_{jj}\end{matrix}$ |

Once these steps are completed the Analytical Engine can supply the “next best question” in a dynamic query as follows:

1. Select the dependent variable X_{d}.

2. Select an independent Xᵢ with the highest correlation to X_{d}. If Xᵢ has already been selected, select the next best one.

3. Continue till there is no independent variables or some criteria has been met (e.g., no significance change in R2).

Classification methods can also be used by the Analytical Engine to supply the next best question. The analytical engine selects the variable to be examined next (the “next best question”) in order to obtain the maximum impact on the target probability (e.g. probability of default in credit assessment). The user can decide at what point to stop asking questions by examining that probability.

The general structure of this Knowledge Entity for using classification for dynamic query is

TABLE 34

| | X₁ | . . . | Xⱼ | . . . | Xₙ |
|---|---|---|---|---|---|
| X₁ | N₁₁ | . . . | N₁ⱼ | . . . | N₁ₙ |
| . . . | . . . | . . . | . . . | . . . | . . . |
| Xᵢ | Nᵢ₁ | . . . | Nᵢⱼ | . . . | Nᵢₙ |
| . . . | . . . | . . . | . . . | . . . | . . . |
| Xₘ | Nₘ₁ | . . . | Nₘⱼ | . . . | Nₘₙ |

where the . . . are “ditto” marks.

The analytical engine uses this knowledge entity as follows:

1. Calculate Tⱼ=□Nᵢⱼ (i=l . . . m; j=l . . . n)

2. Select X_{c} (column variables, c=l . . . n) with the highest T. If X_{c} has already been selected, select the next best one.

3. Calculate Sᵢ=Sᵢ×(N_{ic}/Nᵢᵢ) or Sᵢ=Sᵢ×(N_{ic}/□N_{ic}) for all variables (i=l . . . m)

4. Select Xᵣ (row variables, r=l . . . m) with the highest S. If Xᵣ has already been selected, select the next best one.

5. Select Rule Out (Exclude) or Rule In (Include) strategy

a. Rule Out: calculate Tⱼ=Nᵣⱼ/Nᵣᵣ for all variables where Xᵣ< >Xⱼ (j=l . . . n)

b. Rule In: calculate Tⱼ=Nᵣⱼ/□Nᵢⱼ for all variables where Xᵣ< >Xⱼ (j=l . . . n

6. Go to step 2 and repeat steps 2 through 5 until the desired target probability is reached or exceeded.

### Normalized Knowledge Entity

Some embodiments preferably employ particular forms of the knowledge entity. For example, if the knowledge elements are normalized the performance of some modeling methods can be improved. A normalized knowledge entity can be expressed in terms of well known statistical quantities termed “Z” values. To do this, □Xᵢ, □XᵢXⱼ, □ and □ can be extracted from the un-normalized knowledge entity and used as shown below: Then, returning again to the three dryer data of Table 4

TABLE 35

| | |
|---|---|
| (1) | ${Z}_{i} = \frac{{X}_{i} - {μ}_{i}}{{σ}_{i}}$ |
| (2) | $\begin{matrix}\sum {Z}_{i} = \sum \frac{{X}_{i} - {μ}_{i}}{{σ}_{i}} = \frac{\sum {X}_{i} - N {μ}_{i}}{{σ}_{i}} \\ = \frac{\sum {X}_{i} - \sum {X}_{i}}{{σ}_{i}} = 0\end{matrix}$ |
| (3) | $\begin{matrix}\sum {Z}_{i} {Z}_{j} = \sum ( \frac{{X}_{i} - {μ}_{i}}{{σ}_{i}} \times \frac{{X}_{j} - {μ}_{j}}{{σ}_{j}} ) \\ = \sum ( \frac{{X}_{i} {X}_{j} - {X}_{i} {μ}_{j} - {μ}_{i} {X}_{j} + {μ}_{i} {μ}_{j}}{{σ}_{i} {σ}_{j}} ) \\ = \frac{\sum {X}_{i} {X}_{j} - {μ}_{j} \sum {X}_{i} - {μ}_{i} \sum {X}_{j} + ( \frac{{n}_{i} + {n}_{j}}{2} ) {μ}_{i} {μ}_{j}}{{σ}_{i} {σ}_{j}}\end{matrix}$ |

where:

$\begin{matrix}{μ}_{i} = \frac{\sum {X}_{i}}{{N}_{i}} , {μ}_{j} = \frac{\sum {X}_{j}}{{N}_{j}} \\ {σ}_{i} = \sqrt{\frac{\sum {X}_{i} {X}_{i} - \frac{\sum {X}_{i}}{{N}_{i}}}{{N}_{i}}} , {σ}_{j} = \sqrt{\frac{\sum {X}_{j} {X}_{j} - \frac{\sum {X}_{j}}{{N}_{j}}}{{N}_{j}}}\end{matrix}$

The un-normalized knowledge entity was given in Table 12. and the normalized one is provided below.

### Normalized Knowledge Entity for the Sample Dataset:

TABLE 36

| | Z₁ | Z₂ | Z₃ |
|---|---|---|---|
| Z₁ | N₁₁ = 6 | N₁₂ = 6 | N₁₃ = 6 |
| | □ Z₁ = 0 | □ Z₁ = 0 | □ Z₁ = 0 |
| | □ Z₁ = 0 | □ Z₂ = 0 | □ Z₃ = 0 |
| | □ Z₁Z₁ = 6 | □ Z₁Z₂ = 5.024615 | □ Z₁Z₃ = 5.756419 |
| Z₂ | N₂₁ = 6 | N₂₂ = 6 | N₂₃ = 6 |
| | □ Z₂ = 0 | □ Z₂ = 0 | □ Z₂ = 0 |
| | □ Z₁ = 0 | □ Z₁ = 0 | □ Z₃ = 0 |
| | □ Z₂Z₁ = 5.024615 | □ Z₂Z₂ = 6 | □ Z₂Z₃ = 5.400893 |
| Z₃ | N₃₁ = 6 | N₃₂ = 6 | N₃₃ = 6 |
| | □ Z₃ = 0 | □ Z₃ = 0 | □ Z₃ = 0 |
| | □ Z₁ = 0 | □ Z₂ = 0 | □ Z₃ = 0 |
| | □ Z₃Z₁ = 5.756419 | □ Z₃Z₂ = 5.400893 | □ Z₃Z₃ = 6 |

### Serialized Knowledge Entity

It is also possible to serialize and disperse the knowledge entity to facilitate some software applications.

The general structure of the knowledge entity:

TABLE 37

| | X₁ | . . . | Xⱼ | . . . | Xₙ |
|---|---|---|---|---|---|
| X₁ | W₁₁ | . . . | W₁ⱼ | . . . | W₁ₙ |
| . . . | . . . | . . . | . . . | . . . | . . . |
| X₁ | Wᵢ₁ | . . . | Wᵢⱼ | . . . | Wᵢₙ |
| . . . | . . . | . . . | . . . | . . . | . . . |
| Xₘ | Wₘ₁ | . . . | Wₘⱼ | . . . | Wₘₙ |

can be written as the serialized and dispersed structure:

TABLE 38

| | | |
|---|---|---|
| X₁ | X₁ | W₁₁ |
| X₁ | Xⱼ | W₁ⱼ |
| X₁ | Xₙ | W₁ₙ |
| . | . | . |
| . | . | . |
| . | . | . |
| Xᵢ | X₁ | Wᵢ₁ |
| Xᵢ | Xⱼ | Wᵢⱼ |
| Xᵢ | Xₙ | Wᵢₙ |
| . | . | . |
| . | . | . |
| . | . | . |
| Xₘ | X₁ | Wₘ₁ |
| Xₘ | Xⱼ | Wₘⱼ |
| Xₘ | Xₙ | Wₘₙ |

then the knowledge entity for the three dryer data (Table 4) used above becomes:

TABLE 39

| | | | | | |
|---|---|---|---|---|---|
| X₁ | X₁ | N₁₁ = 6 | □ X₁ = 15 | □ X₁ = 15 | □ X₁X₁ = 43 |
| X₁ | X₂ | N₁₂ = 6 | □ X₁ = 15 | □ X₂ = 20 | □ X₁X₂ = 56 |
| X₁ | X₃ | N₁₃ = 6 | □ X₁ = 15 | □ X₃ = 36 | □ X₁X₃ = 99 |
| X₂ | X₂ | N₂₂ = 6 | □ X₂ = 20 | □ X₂ = 20 | □ X₂X₂ = 76 |
| X₂ | X₃ | N₂₃ = 6 | □ X₂ = 20 | □ X₃ = 36 | □ X₂X₃ = 131 |
| X₃ | X₃ | N₃₃ = 6 | □ X₃ = 36 | □ X₃ = 36 | □ X₃X₃ = 232 |

### Robust Bayesian Classification

In some cases, the appropriate model for classification of a categorical variable may be Robust Bayesian Classification, which is based on Bayes's rule of conditional probability:

$$P ( {C}_{k} \vert x ) = \frac{P ( x \vert {C}_{k} ) P ( {C}_{k} )}{P ( x )}$$

Where:

P(Cₖ|x) is the conditional probability of Cₖ given x

P(x|Cₖ) is the conditional probability of x given Cₖ

P(Cₖ) is the prior probability of Cₖ

P(x) is the prior probability of x

Bayes's rule can be summarized in this simple form:

$$posterior = \frac{likelihood \times prior}{normalization factor}$$

A discriminant function may be based on Bayes's rule for each value k of a categorical variable Y:

yₖ(x)=ln P(x|Cₖ)+ln P(Cₖ)

If each of the class-conditional density functions P(x|Cₖ) is taken to be an independent normal distribution, then we have:

yₖ(x)=−½(x−μₖ)^{T}Σₖ⁻¹(x−μₖ)−½ln|Σₖ|+ln P(Cₖ)

There are three elements, which the analytical engine needs to extract from the knowledge entity 46, namely, the mean vector (□ₖ), the covariance matrix (□ₖ), and the prior probability of Cₖ(P(Cₖ)).

There are five steps to create the discriminant equation:

Step 1: Slice out the knowledge entity 46 for any Cₖ where Cₖ is a Xᵢ.

Step 2: Create the □ vector by simply using two elements in the knowledge entity 46 □X and N where □=□X/N

Step 3: Create the the covariance matrix (□ₖ), by using four basic elements in the knowledge entity 46 as follows:

$${Covar}_{i , j} = \frac{\sum {X}_{i} {X}_{j} - \frac{( \sum {X}_{i} \sum {X}_{j} )}{{N}_{ij}}}{{N}_{ij}}$$

Step 4: Calculate the P(Cₖ) by using two elements in the knowledge entity 46 □X and N. If Cₖ=Xᵢ then

P(Xᵢ)=□Xᵢ/NᵢᵢS

Step 5 k discriminant functions

In the prediction phase these k models compete with each other and the model with the highest value will be the winner.

### Naïve Bayesian Classification

It may be desirable to use a simplification of Bayesian Classification when the variables are independent. This simplification is called Naïve Bayesian Classification and also uses Bayes 's rule of conditional probability:

$$P ( {C}_{k} \vert x ) = \frac{P ( x \vert {C}_{k} ) P ( {C}_{k} )}{P ( x )}$$

Where:

P(Cₖ|x) is the conditional probability of Cₖ given x

P(x|Cₖ) is the conditional probability of x given Cₖ

P(Cₖ) is the prior probability of Cₖ

P(x) is the prior probability of x

When the variables are independent, Bayes's rule may be written as follows:

$$P ( {C}_{k} \vert x ) = P ( {x}_{l} \vert {C}_{k} ) \times P ( {x}_{2} \vert {C}_{k} ) \times P ( {x}_{3} \vert {C}_{k} ) \times … \times P ( {x}_{n} \vert {C}_{k} ) \times \frac{P ( {C}_{k} )}{P ( x )}$$

It is noted that P(x) is a normalization factor.

There are five steps to create the discriminant equation:

Step 1: Select a row of the knowledge entity 46 for any Cₖ and suppose Cₖ=Xᵢ

Step 2a. If xⱼ is a value for a categorical variable Xⱼ we have P(xⱼ|Xᵢ)=□Xⱼ/□Xᵢ. We get □Xⱼ from Wᵢⱼ and □Xᵢ from Wᵢᵢ.

Step 2b. If xⱼ is a value for a numerical variable Xⱼ we calculate P(xⱼ|Xᵢ) by using a density function like this:

$$f ( x ) = \frac{1}{\sqrt{2 π σ}} {ⅇ}^{\frac{- {( x - μ )}^{2}}{2 {σ}^{2}}}$$

Where:

□=□Xᵢ/Nᵢᵢ

□ᵢ=sqrt(Covarᵢᵢ)

Step 3. Calculate the P(Cₖ) by using two elements in the knowledge entity 46 □X and N. If Cₖ=Xᵢ then

P(Xᵢ)=□Xᵢ/Nᵢᵢ

Step 4: Calculate P(Cₖ|x) using

$$P ( {C}_{k} \vert x ) = P ( {x}_{1} \vert {C}_{k} ) \times P ( {x}_{2} \vert {C}_{k} ) \times P ( {x}_{3} \vert {C}_{k} ) \times ... \times P ( {x}_{n} \vert {C}_{k} ) \times \frac{P ( {C}_{k} )}{P ( x )}$$

In the prediction phase these k models compete with each other and the model with the highest value will be the winner.

### Markov Chain

Another possible model is a Markov Chain, which is particularly expedient for situations where observed values can be regarded as “states.” In a conventional Markov Chain, each successive state depends only on the state immediately before it. The Markov Chain can be used to predict future states.

Let X be a set of states (X₁, X₂, X₃ . . . Xₙ) and S be a sequence of random variables (S₀, S₁, S₂ . . . Sₗ) each with sample space X. If the probability of transition from state Xᵢ to Xⱼ depends only on state Xᵢ and not to the previous states then the process is said to be a Markov chain. A time independent Markov chain is called a stationary Markov chain. A stationary Markov chain can be described by an Nby N transition matrix, T, where N is the state space and with entries Tᵢⱼ=P(Sₖ=Xᵢ|Sₖ₋₁=Xⱼ).

In a k^{th} order Markov chain, the distribution of Sₖ depends only on the k variables immediately preceding it. In a 1^{th} order Markov chain, for example, the distribution of Sₖ depends only on the Sₖ₋₁. The transition matrix Tᵢⱼ for a 1^{st} order Markov chain is the same as Nᵢⱼ in the knowledge entity 46. Table 40 shows the transition matrix T for a 1st order Markov chain extracted from the knowledge entity 46.

TABLE 40

| | X₁ | . . . | Xⱼ | . . . | Xₙ |
|---|---|---|---|---|---|
| X₁ | N₁₁ | . . . | N₁ⱼ | . . . | N₁ₙ |
| . . . | . . . | . . . | . . . | . . . | . . . |
| Xᵢ | Nᵢ₁ | . . . | Nᵢⱼ | . . . | Nᵢₙ |
| . . . | . . . | . . . | . . . | . . . | . . . |
| Xₙ | Nₙ₁ | . . . | Nₙⱼ | . . . | Nₙₙ |

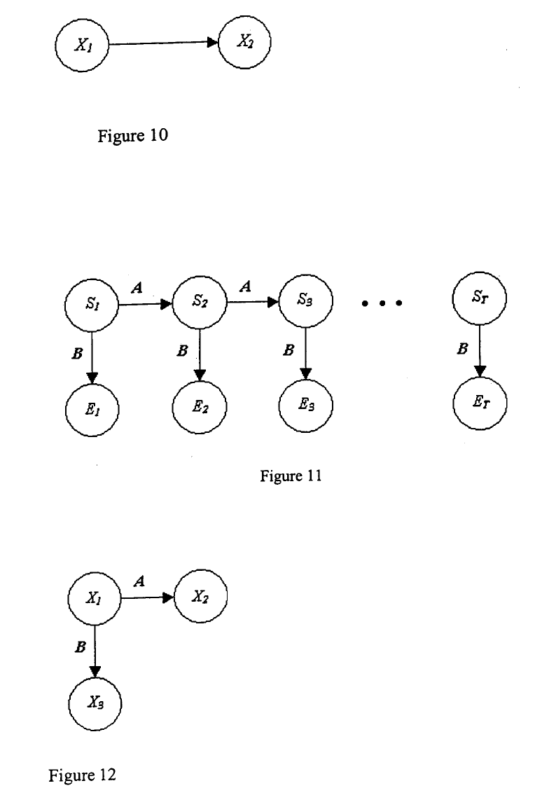

One weakness of a Markov chain is its unidirectionality which means Sₖ depends just on Sₖ₋₁ not Sₖ₊₁. Using the knowledge entity 46 can solve this problem and even give more flexibility to standard Markov chains. A 1^{st} order Markov chain with a simple graph with two nodes (variables) and a connection as shown in FIG. 10.

Suppose X₁ and X₂ have two states A and B then the knowledge entity 46 will be of the form shown in Table 41.

A

TABLE 41

| | |
|---|---|
| X₁ | X₂ |

| | | X_{1A} | X_{1B} | X_{2A} | X_{2B} |
|---|---|---|---|---|---|
| X₁ | X_{1A} | W_{1A1A} | W_{1A1B} | W_{1A2A} | W_{1A2B} |
| | X_{1B} | W_{1B1A} | W_{1B1B} | W_{1B2A} | W_{1B2B} |
| X₂ | X_{2A} | W_{2A1A} | W_{2A1B} | W_{2A2A} | W_{2A2B} |
| | X_{2B} | W_{2B1A} | W_{2B1B} | W_{2B2A} | W_{2B2B} |

It is noted that W_{#A·B} indicates the set of combinations of variables at the intersection of row #A and column *B. The use of the knowledge entity 46 produces a bidirectional Markov Chain. It will be recognised that each of the above operations relating to the knowledge entity 46 can be applied to the knowledge entity for the Markov Chain. It is also possible to have a Markov chain with a combination of different order in one knowledge entity 46 and also a continuous Markov chain. These Markov Chains may then be used to predict future states.

### Hidden Markov Model

In a more sophisticated variant of the Markov Model, the states are hidden and are observed through output or evidence nodes. The actual states cannot be directly observed, but the probability of a sequence of states given the output nodes may be obtained.

A Hidden Markov Model (HMM) is a graphical model in the form of a chain. In a typical HMM there is a sequence of state or hidden nodes S with a set of states (X₁, X₂, X₃ . . . Xₙ), the output or evidence nodes E a set of possible outputs (Y₁, Y₂, Y₃ . . . Yₙ), a transition probability matrix A for the hidden nodes and a emission probability matrix B for the output nodes as shown in FIG. 11.

Table 42 shows a transition matrix A for a 1^{st} order Hidden Markov Model extracted from knowledge entity 46.

TABLE 42

| | X₁ | . . . | Xⱼ | . . . | Xₙ |
|---|---|---|---|---|---|
| X₁ | N₁₁ | . . . | N₁ⱼ | . . . | N₁ₙ |
| . . . | . . . | . . . | . . . | . . . | . . . |
| Xᵢ | Nᵢ₁ | . . . | Nᵢⱼ | . . . | Nᵢₙ |
| . . . | . . . | . . . | . . . | . . . | . . . |
| Xₙ | Nₙ₁ | . . . | Nₙⱼ | . . . | Nₙₙ |

Table 43 shows a transition matrix B for a 1^{st} order Markov chain extracted from knowledge entity 46

TABLE 43

| | X₁ | . . . | Xⱼ | . . . | Xₙ |
|---|---|---|---|---|---|
| Y₁ | N₁₁ | . . . | N₁ⱼ | . . . | N₁ₙ |
| . . . | . . . | . . . | . . . | . . . | . . . |
| Yᵢ | Nᵢ₁ | . . . | Nᵢⱼ | . . . | Nᵢₙ |
| . . . | . . . | . . . | . . . | . . . | . . . |
| Yₙ | Nₙ₁ | . . . | Nₙⱼ | . . . | Nₙₙ |

Each of the properties of the knowledge entity 46 can be applied to the standard Hidden Markov Model. In fact we can show a 1^{st} HMM with a simple graph with three nodes (variables) and two connections as shown in FIG. 12.

Suppose X₁ and X₂ have two states (values) A and B and X₃ has another two values C and D then the knowledge entity 46 will be as shown in Table 44, which represents a 1^{st} order Hidden Markov Model.

TABLE 44

| | | X₁ | | X₂ | | X₃ | |
|---|---|---|---|---|---|---|---|
| | | X_{1A} | X_{1B} | X_{2A} | X_{2B} | X_{3C} | X_{3D} |
| X₁ | X_{1A} | W_{1A1A} | W_{1A1B} | W_{1A2A} | W_{1A2B} | W_{1A3C} | W_{1A3D} |
| | X_{1B} | W_{1B1A} | W_{1B1B} | W_{1B2A} | W_{1B2B} | W_{1B3C} | W_{1B3D} |
| X₂ | X_{2A} | W_{2A1A} | W_{2A1B} | W_{2A2A} | W_{2A2B} | W_{2A3C} | W_{2A3D} |
| | X_{2B} | W_{2B1A} | W_{2B1B} | W_{2B2A} | W_{2B2B} | W_{2B3C} | W_{2B3D} |
| X₃ | X_{3C} | W_{3C1A} | W_{3C1B} | W_{3C2A} | W_{3C2B} | W_{3C3C} | W_{3C3D} |
| | X_{3D} | W_{3D1A} | W_{3D1B} | W_{3D2A} | W_{3D2B} | W_{3D3C} | W_{3D3D} |

The Hidden Markov Model can then be used to predict future states and to determine the probability of a sequence of states given the output and/or observed values.

### Principal Component Analysis

Another commonly used model is Principal Component Analysis (PCA), which is used in certain types of analysis. Principal Component Analysis seeks to determine the most important independent variables.

There are five steps to calculate principal components for a dataset.

Step 1: Compute the covariance or correlation matrix.

Step 2: Find its eigenvalues and eigenvectors.

Step 3: Sort the eigenvalues from large to small.

Step 4. Name the ordered eigenvalues as □₁, □₂, □_{□} . . . and the corresponding eigenvectors as ν₁, ν₂, ν₃, . . .

Step 5: Select the k largest eigenvalues.

The covariance matrix or correlation matrix are the only prerequisites for PCA which are easily can be derived from knowledge entity 46.

The Covariance matrix extracted from knowledge entity 46.

TABLE 45

| | X_{J} |
|---|---|
| Xᵢ | ${Covar}_{ij} = \frac{\sum {X}_{i} {X}_{j} - \frac{( \sum {X}_{i} \sum {X}_{j} )}{{N}_{ij}}}{{N}_{ij}}$ |

The Correlation matrix.

TABLE 46

| | X_{J} |
|---|---|
| Xᵢ | $\begin{matrix}{R}_{ij} = \frac{{Covar}_{ij}}{\sqrt{{Var}_{i} {Var}_{j}}} \\ where \text{:} \\ {Var}_{i} = {Covar}_{ii} \\ {Var}_{j} = {Covar}_{jj}\end{matrix}$ |

The principal components may then be used to provide an indication of the relative importance of the independent variables based on the covariance or correlation tables computed from the knowledge entity 46, without requiring re-computation based on the entire collection of data.

It will therefore be recognised that the controller 40 can switch among any of the above models, and the modeller 48 will be able to use the same knowledge entity 46 for the new model. That is, the analytical engine can use the same knowledge entity for many modelling methods. There are many models in addition to the ones mentioned above that can be used by the analytical engine. For example, the OneR Classification Method, Linear Support Vector Machine and Linear Discriminant Analysis are all readily employed by this engine. Pertinent details are provided in the following paragraphs.

The OneR Method

The main goal in the OneR Method is to find the best independent (Xj) variable which can explain the dependent variable (Xi). If the dependent variable is categorical there are many ways that the analytical engine can find the best dependent variable (e.g. Bayes rule, Entropy, Chi2, and Gini index). All of these ways can employ the knowledge elements of the knowledge entity. If the dependent variable is numerical the correlation matrix (again, extracted from the knowledge entity) can be used by the analytical engine to find the best independent variable. Alternatively, the engine can transform the numerical variable to a categorical variable by a discretization technique.

Linear Support Vector Machine

The Linear Support Vector Machine can be modeled by using the covariance matrix. As shown in [0079] the covariance matrix can easily be computed from the knowledge elements of the knowledge entity by the analytical engine.

Linear Discriminant Analysis

Linear Discriminant Analysis is a classification technique and can be modeled by the analytical engine using the covariance matrix. As shown in [0079] the covariance matrix can easily be computed from the knowledge elements of the knowledge entity.

Model Diversity

As evident above, use of the analytical engine with even a single knowledge entity can provide extremely rapid model development and great diversity in models. Such easily obtained diversity is highly desirable when seeking the most suitable model for a given purpose. In using the analytical engine, diversity originates both from the intelligent properties awarded to any single model (e.g. addition and removal of variables, dimension reduction) and the property that switching modelling methods does not require new computations on the entire database for a wide variety of modelling methods. Once provided with the models, there are many methods for determining which one is best (“model discrimination”) or which prediction is best. The analytical engine makes model generation so comprehensive and easy that for the latter problem, if desired, several models can be tested and the prediction accepted can be the one which the majority of models support.

It will be recognised that certain uses of the knowledge entity 46 by the analytical engine will typically use certain models. The following examples illustrate several areas where the above models can be used. It is noted that the knowledge entity 46 facilitates changing between each of the models for each of the following examples.

The above description of the invention has focused upon control of a process involving numerical values. As will be seen below, the underlying principles are actually much more general in applicability than that.

Control of a Robotic Arm

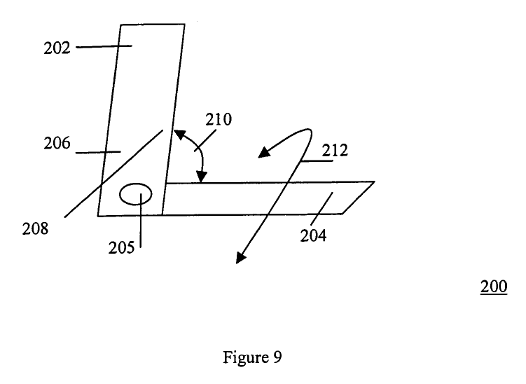

In this embodiment an amputee has been fitted with a robotic arm 200 as shown in FIG. 9. The arm has an upper portion 202 and a forearm 204 connected by a joint 205. The movement of the robotic arm depend upon two sensors 206, 208, each of which generate a voltage based upon direction from the person's brain. One of these sensors 208 is termed “Biceps” and is for the upper muscle of the arm. The second 206 is termed “Triceps” and is for the lower muscle. The arm moves in response to these two signals and this movement has one of four possibilities: flexion 210 (the arm flexes), extension 210 (the arm extends), pronation 212 (the arm rotates downwards) and supination 212 (the arm rotates upwards). The usual way of relating movement to the sensor signals would be to gather a large amount of data on what movement corresponds to what sensor signals and to train a classification method with this data. The resulting relationship would then be used without modification to move the arm in response to the signals. The difficulty with this approach is its inflexibity. For example, with wear of parts in the arm the relationship determined from training may no longer be valid and a complete new retraining would be necessary. Other problems can include: the failure of one of the sensors or the need to add a third sensor. The knowledge entity 46 described above may be used by the analytical engine to develop a control of the arm divided into three steps: learner, modeller and predictor. The result is that control of the arm can then adapt to new situations as in the previous example.

The previous example showed a situation where all the variables were numeric and linear regression was used following the learner. This example shows how the learner can employ categorical values and how it can work with a classification method.

Exemplary data collected for use by the robotic arm is as follows:

TABLE 47

| Biceps | Triceps | Movement |
|---|---|---|
| 13 | 31 | Flexion |
| 14 | 30 | Flexion |
| 10 | 31 | Flexion |
| 90 | 22 | Extension |
| 87 | 19 | Extension |
| 65 | 15 | Extension |
| 28 | 16 | Pronation |
| 27 | 12 | Pronation |
| 33 | 11 | Pronation |
| 72 | 24 | Supination |
| 70 | 36 | Supination |
| 58 | 28 | Supination |
| . | . | . |
| . | . | . |
| . | . | . |

The record corresponding to the first measurement of 1: 13, 31, 1, 0, 0, 0 is as follows using the set of combinations nᵢⱼ, ΣXᵢ, ΣXⱼ, ΣXᵢXⱼ is as set out below in Table 48.

TABLE 48

| | | | | Movement | | | |
|---|---|---|---|---|---|---|---|
| | | Biceps | Triceps | Flexion | Extension | Pronation | Supination |
| | Biceps | 1 | 1 | 1 | 1 | 1 | 1 |
| | | 13 | 13 | 13 | 13 | 13 | 13 |
| | | 13 | 31 | 1 | 0 | 0 | 0 |
| | | 169 | 403 | 13 | 0 | 0 | 0 |
| | | 1 | 1 | 1 | 1 | 1 | 1 |
| | Triceps | 31 | 31 | 31 | 31 | 31 | 31 |
| | | 13 | 31 | 1 | 0 | 0 | 0 |
| | | 403 | 961 | 31 | 0 | 0 | 0 |
| Movement | Flexion | 1 | 1 | 1 | 1 | 1 | 1 |
| | | 1 | 1 | 1 | 1 | 1 | 1 |
| | | 13 | 31 | 1 | 0 | 0 | 0 |
| | | 13 | 31 | 1 | 0 | 0 | 0 |
| | Extension | 1 | 1 | 1 | 1 | 1 | 1 |
| | | 0 | 0 | 0 | 0 | 0 | 0 |
| | | 13 | 31 | 1 | 0 | 0 | 0 |
| | | 0 | 0 | 0 | 0 | 0 | 0 |
| | Pronation | 1 | 1 | 1 | 1 | 1 | 1 |
| | | 0 | 0 | 0 | 0 | 0 | 0 |
| | | 13 | 31 | 1 | 0 | 0 | 0 |
| | | 0 | 0 | 0 | 0 | 0 | 0 |
| | Supination | 1 | 1 | 1 | 1 | 1 | 1 |
| | | 0 | 0 | 0 | 0 | 0 | 0 |
| | | 13 | 31 | 1 | 0 | 0 | 0 |
| | | 0 | 0 | 0 | 0 | 0 | 0 |

Once records as shown in Table 48 have been learned by the learner 44 into the knowledge entity 46, the modeller 48 can construct appropriate models of various movements. The predictor can then compute the values of the four models:

Flexion=a+b₁*Biceps+b₂*Triceps

Extension=a+b₁*Biceps+b₂*Triceps

Pronation=a+b₁*Biceps+b₂*Triceps

Supination=a+b₁*Biceps+b₂*Triceps

When signals are received from the Biceps and Triceps sensors the four possible arm movements are calculated. The Movement with the highest value is the one which the arm implements.

### Prediction of the Start Codon in Genomes

Each DNA (deoxy-ribonucleic acid) molecule is a long chain of nucleotides of four different types, adenine (A), cytosine (C), thymine (T), and guanine (G). The linear ordering of the nucleotides determines the genetic information. The genome is the totality of DNA stored in chromosomes typical of each species and a gene is a part of DNA sequence which codes for a protein. Genes are expressed by transcription from DNA to mRNA followed by translation from mRNA to protein. mRNA (messenger ribonucleic acid) is chemically similar to DNA, with the exception that the base thymine is replaced with the base uracil (U). A typical gene consists of these functional parts: promoter->start codon->exon->stop codon. The region immediately upstream from the gene is the promoter and there is a separate promoter for each gene. The promoter controls the transcription process in genes and the start codon is a triplet (usually ATG) where the translation starts. The exon is the coding portion of the gene and the start codon is a triplet where the translation stops. Prediction of the start codon from a measured length of DNA sequence may be performed by using the Markov Chain to calculate the probability of the whole sequence. That is, given a sequence s, and given a Markov chain M, the basic question to answer is, “What is the probability that the sequence s is generated by the Markov chain M? The problems with the conventional Markov chain were described above. Here these problems can cause poor predictability because in fact, in genes the next state, not just the previous state, does affect the structure of the start codon.

### ATTTCTAGGAGTACC . . .

TABLE 49

| X₁ | X₂ |
|---|---|
| A | T |
| T | T |
| T | C |
| C | T |
| T | A |
| A | G |
| G | G |
| G | A |
| A | G |
| G | T |
| T | A |
| A | C |
| C | C |
| . | . |
| . | . |
| . | . |

Classic Markov Chain:

Record 1: A T

TABLE 50

X₁

| | | A | C | G | T |
|---|---|---|---|---|---|
| X₂ | A | 0 | 0 | 0 | 0 |
| | C | 0 | 0 | 0 | 0 |
| | G | 0 | 0 | 0 | 0 |
| | T | 1 | 0 | 0 | 0 |

A Markov Chain stored in knowledge entity 46 is constructed as follows:

The first Record 1: 1, 0, 0, 0, 0, 0, 0, 1 is transformed to the table:

TABLE 51

| | |
|---|---|
| X₁ | X₂ |

| | | A | C | G | T | A | C | G | T |
|---|---|---|---|---|---|---|---|---|---|
| X₁ | A | 1 | 1 | 1 | 1 | 1 | 1 | 1 | 1 |
| | | 1 | 1 | 1 | 1 | 1 | 1 | 1 | 1 |
| | | 1 | 0 | 0 | 0 | 0 | 0 | 0 | 1 |
| | | 1 | 0 | 0 | 0 | 0 | 0 | 0 | 1 |
| | C | 1 | 1 | 1 | 1 | 1 | 1 | 1 | 1 |
| | | 0 | 0 | 0 | 0 | 0 | 0 | 0 | 0 |
| | | 1 | 0 | 0 | 0 | 0 | 0 | 0 | 1 |
| | | 0 | 0 | 0 | 0 | 0 | 0 | 0 | 0 |
| | G | 1 | 1 | 1 | 1 | 1 | 1 | 1 | 1 |
| | | 0 | 0 | 0 | 0 | 0 | 0 | 0 | 0 |
| | | 1 | 0 | 0 | 0 | 0 | 0 | 0 | 1 |
| | | 0 | 0 | 0 | 0 | 0 | 0 | 0 | 0 |
| | T | 1 | 1 | 1 | 1 | 1 | 1 | 1 | 1 |
| | | 0 | 0 | 0 | 0 | 0 | 0 | 0 | 0 |
| | | 1 | 0 | 0 | 0 | 0 | 0 | 0 | 1 |
| | | 0 | 0 | 0 | 0 | 0 | 0 | 0 | 0 |
| | A | 1 | 1 | 1 | 1 | 1 | 1 | 1 | 1 |
| | | 0 | 0 | 0 | 0 | 0 | 0 | 0 | 0 |
| | | 1 | 0 | 0 | 0 | 0 | 0 | 0 | 1 |
| | | 0 | 0 | 0 | 0 | 0 | 0 | 0 | 0 |
| | C | 1 | 1 | 1 | 1 | 1 | 1 | 1 | 1 |
| | | 0 | 0 | 0 | 0 | 0 | 0 | 0 | 0 |
| | | 1 | 0 | 0 | 0 | 0 | 0 | 0 | 1 |
| | | 0 | 0 | 0 | 0 | 0 | 0 | 0 | 0 |
| | G | 1 | 1 | 1 | 1 | 1 | 1 | 1 | 1 |
| | | 0 | 0 | 0 | 0 | 0 | 0 | 0 | 0 |
| | | 1 | 0 | 0 | 0 | 0 | 0 | 0 | 1 |
| | | 0 | 0 | 0 | 0 | 0 | 0 | 0 | 0 |
| | T | 1 | 1 | 1 | 1 | 1 | 1 | 1 | 1 |
| | | 1 | 1 | 1 | 1 | 1 | 1 | 1 | 1 |
| | | 1 | 0 | 0 | 0 | 0 | 0 | 0 | 1 |
| | | 1 | 0 | 0 | 0 | 0 | 0 | 0 | 1 |

X₂

The knowledge entity 46 is built up by the analytical engine from records relating to each measurements. Controller 40 can then operate to determine the probability that a start codon is generated by the Markov Chain represented in the knowledge entity 46.

### Sales Prediction

The next embodiment shows that the model to be used with the learner in the analytical engine can be non-linear in the independent variable. In this embodiment sales from a business are to be related to the number of competitors' stores in the area, average age of the population in the area and the population of the area. The example shows that the presence of a non-linear variable can easily be accommodated by the method. Here, it was decided that the logarithm of the population should be used instead of simply the population. The knowledge entity is then formed as follows:

TABLE 52

| No. of | | Log | |
|---|---|---|---|
| Competitors | Average Age | (Population) | Sales |
| 2 | 40 | 4.4 | 850000 |
| 2 | 37 | 4.4 | 1100000 |
| 3 | 36 | 4.3 | 920000 |
| 2 | 31 | 4.2 | 950000 |
| 1 | 42 | 4.6 | 107000 |
| . . . | . . . | . . . | . . . |

From the record: 2, 40, 4.4, 850000, the knowledge entity 46 is generated as set out below in Table 53.

TABLE 53

| | No. of | | Log | |
|---|---|---|---|---|
| | Competitors | Average Age | (Population) | Sales |
| No. of | 1 | 1 | 1 | 1 |
| Com- | 2 | 2 | 2 | 2 |
| petitors | 2 | 40 | 4.4 | 850000 |
| | 4 | 80 | 8.8 | 1700000 |
| Average | 1 | 1 | 1 | 1 |
| Age | 40 | 40 | 40 | 40 |
| | 2 | 40 | 4.4 | 850000 |
| | 80 | 1600 | 176 | 34000000 |
| Log | 1 | 1 | 1 | 1 |
| (Popu- | 4.4 | 4.4 | 4.4 | 4.4 |
| lation) | 2 | 40 | 4.4 | 850000 |
| | 8.8 | 176 | 19.36 | 3740000 |
| Sales | 1 | 1 | 1 | 1 |
| | 850000 | 850000 | 850000 | 850000 |
| | 2 | 40 | 4.4 | 850000 |
| | 1700000 | 34000000 | 3740000 | 722500000000 |

The sales are modelled using the relationship:

Sales=a+b₁*No. of Competitors+b₂*Average Age+b₃*Log (Population)

The coefficients may then be derived from the knowledge entity 46 as described above.

The ability to diagnose the cause of problems, whether in machines or human beings is an important application of the knowledge entity 46.

### Disease Diagnosis

In this part we want to use the analytical engine to predict a hemolytic disease of the newborn by means of three variables (sex, blood hemoglobin, and blood bilirubin).

TABLE 54

| Newborn | Sex | Hemoglobin | Bilirubin |
|---|---|---|---|
| Survival | Female | 18 | 2.2 |
| Survival | Male | 16 | 4.1 |
| Death | Female | 7.5 | 6.7 |
| Death | Male | 3.5 | 4.2 |
| . . . | . . . | . . . | . . . |

A knowledge entity for constructing a naïve Bayesian classifier would be as follow (just for first and forth records):

Record 1: Survival, Female, 18, 2.2

Record 4: Death, Male, 3.5, 4.2

There is a categorical value then we transform it to numerical one:

Record 1 (transformed): 1, 0, 1, 0, 18, 2.2

Record 4: 0, 1, 0, 1, 3.5, 4.2

TABLE 55

| | Newborn | | Sex | | | |
|---|---|---|---|---|---|---|
| | Survival | Death | Female | Male | Hemoglobin | Bilirubin |
| Survival | 2 | 2 | 1 | 1 | 1 | 1 |
| | 1 | 1 | 1 | 0 | 18 | 2.2 |
| | 1 | 1 | 1 | 0 | 324 | 4.84 |
| Death | 2 | 2 | 1 | 1 | 1 | 1 |
| | 1 | 1 | 0 | 1 | 3.5 | 4.2 |
| | 1 | 1 | 0 | 1 | 12.25 | 17.64 |

As we can see this Knowledge entity is not orthogonal and uses three combinations of the variables (N, □X and □X²) which are enough to model a naïve Bayesian classifier. The knowledge entity 46 may be used to predict survival or death using the Bayesian classification model described above.

From the above examples, it will be recognised that the knowledge entity of FIG. 3 may be applied in many different areas. A sampling of some areas of applicability follows.

### Banking and Credit Scoring

In banking and credit scoring applications, it is often necessary to determine the risk posed by a client, or other measures of relating to the clients finances. In banking and credit scoring, the following variables are often used.

checking_status, duration, credit_history, purpose, credit_amount, savings_status, employment, installment_commitment, personal_status, other_parties, residence_since, property_magnitude, age, other_payment_plans, housing, existing credits, job, num_dependents, own_telephone, foreign_worker, credit_assessment. Dynamic query is particularly important in applications such as credit assessment where an applicant is waiting impatiently for a decision and the assessor has many of questions from which to choose. By having the analytical engine select the “next best question” the assessor can rapidly converge on a decision.

### Bioinformatics and Pharmaceutical Solutions

The example above showed gene prediction using Markov models. There are many other applications to bioinformatics and pharmaceuticals.

In a microarray, the goal is to find a match between a known sequence and that of a disease.

In drug discovery the goal is to determine the performance of drugs as a function of type of drug, characteristics of patients, etc.

### Ecommerce and CRM

Applications to eCommerce and CRM include email analysis, response and marketing.

Fraud Detection

In order to detect fraud on credit cards, the knowledge entity 46 would use variables such as number of credit card transactions, value of transactions, location of transaction, etc.

### Health Care and Human Resources

To perform diagnosis of the cause of abdominal pain uses approximately 1000 different variables.

In an application to the diagnosis of the presence of heart disease, the variables under consideration are:

age, sex, chest pain type, resting blood pressure, blood cholesterol, blood glucose, rest ekg, maximum heart rate, exercise induced angina, extent of narrowing of blood vessels in the heart

### Privacy and Security

The areas of privacy and security often require image analysis, finger print analysis, and face analysis. Each of these areas typically involves many variables relating to the image and to attempt to match images and find patterns.

Retail

In the retail industry, the knowledge entity 46 may be used for inventory control, and sales prediction.

### Sports and Entertainment

The knowledge entity 46 may be used by the analytical engine to collect information on sports events and predict the winner of a future sports event.

The knowledge entity 46 may also be used as a coaching aid.

In computer games, the knowledge entity 46 can manage the data required by the games artificial intelligence systems.

### Stock and Investment Analysis and Prediction

By employing the knowledge entity 46, the analytical engine is particularly adept at handling areas like investment decision making, predicting stock price, where there is a large amount of data which is constantly updated as stock trades are made on the market.

### Telecom, Instrumentation and Machinery

The areas of telecom, instrumentation and machinery have many applications, such as diagnosing problems, and controlling robotics.

### Travel

Yet another application of the analytical engine employing the knowledge entity 46 is as a travel agent. The knowledge entity 46 can collect information about travel preferences, costs of trips, and types of vacations to make predictions related to the particular customer.

From the preceding examples, it will be recognised that the knowledge entity 46 when used with the appropriate methods to form the analytical engine, has broad applicability in many environments. In some embodiments, the knowledge entity 46 has much smaller storage requirements than that required for the equivalent amount of observed data. Some embodiments of the knowledge entity 46 use parallel processing to provide increases in the speed of computations. Some embodiments of the knowledge entity 46 allow models to be changed without re-computation. It will therefore be recognised that in various embodiments, the analytical engine provides an intelligent learning machine that can rapidly learn, predict, control, diagnose, interact, and co-operate in dynamic environments, including for example large quantities of data, and further provides a parallel processing and distributed processing capability.

1) A computer implemented system for enabling data analysis comprising:
A computer linked to one or more data sources adapted to provide to the computer a plurality of knowledge elements; and
An analytical engine, executed by the computer, that relies on one or more of the plurality of knowledge elements to enable intelligent modeling, wherein the analytical engine includes a data management system for accessing and processing the knowledge elements.

2) The computer implemented system claimed in claim 1, wherein the analytical engine defines one or more knowledge entities, each of which is comprised of at least one knowledge element.

3) The computer implemented system as claimed in claim 2, wherein the analytical engine is adapted to update dynamically the knowledge elements with a plurality of records and a plurality of variables.

4) The computer implemented system claimed in claim 2, wherein the knowledge entity consists of a data matrix having a row and a column for each variable, and wherein the knowledge entity accumulates sets of combinations of knowledge elements for each variable in the intersection of the corresponding row and column.

5) The computer implemented system as claimed in claim 4, wherein the analytical engine enables variables and/or records to be dynamically added to, and subtracted from, the knowledge entity.

6) The computer implemented system claimed in claim 5, wherein the analytical engine enables the deletion of a variable by deletion of the corresponding row and/or column, and wherein the knowledge entity remains operative after such deletion.

7) The computer implemented system claimed in claim 5, wherein the analytical engine enables the addition of a variable by addition of a corresponding row and/or column to the knowledge entity, and wherein the knowledge entity remains operative after such addition.

8) The computer implemented system claimed in claim 5, wherein an update of the knowledge entity by the analytical engine does not require substantial re-training or re-calibration of the knowledge elements.

9) The computer implemented system claimed in claim 2, wherein the analytical engine enables application to the knowledge entity of one or more of: incremental learning operations, parallel processing operations, scenario testing operations, dimension reduction operations, dynamic query operations or distributed processing operations.

10) A computer implemented system for enabling data analysis comprising:
a) A computer linked to one or more data sources adapted to provide to the computer a plurality of knowledge elements; and
b) An analytical engine, executed by the computer that relies on one or more of the plurality of knowledge elements to enable intelligent modeling, wherein the analytical engine is linked to a data management system for accessing and processing the knowledge elements.

11) A method of data analysis comprising:
a) Providing an analytical engine, executed by a computer, that relies on one or more of a plurality of knowledge elements to enable intelligent modeling, wherein the analytical engine includes a data management system for accessing and processing the knowledge elements; and
b) Applying the intelligent modeling to the knowledge elements so as to engage in data analysis.

12) A method of enabling parallel processing, comprising the steps of:
a) Providing an analytical engine, executed by a computer, that relies on one or more of a plurality of knowledge elements to enable intelligent modeling, wherein the analytical engine includes a data management system for accessing and processing the knowledge elements;
b) Subdividing one or more databases into a plurality of parts and calculating a knowledge entity for each part using the same or a number of other computers to accomplish the calculations in parallel
c) Combining all or some of the knowledge entities to form one or more combined knowledge entities; and
d) Applying the intelligent modeling to the knowledge elements of the combined knowledge entities so as to engage in data analysis.

13) A method of enabling scenario testing, wherein a scenario consists of a test of a hypothesis, comprising the steps of:
a) Providing an analytical engine, executed by a computer, that relies on one or more of a plurality of knowledge elements to enable intelligent modeling, wherein the analytical engine includes a data management system for accessing and processing the knowledge elements, whereby the analytical engine is responsive to introduction of a hypothesis to create dynamically one or more new intelligent models; and
b) Applying the one or more new intelligent models to see future possibilities, obtain new insights into variable dependencies as well as to assess the ability of the intelligent models to explain data and predict outcomes.

14) A method of enabling dimension reduction, comprising the steps of:
a) Providing an analytical engine, executed by a computer, that relies on one or more of a plurality of knowledge elements to enable intelligent modeling, wherein the analytical engine includes a data management system for accessing and processing the knowledge elements; and
b) Reducing the number of variables in the knowledge entity by the analytical engine defining a new variable based on the combination of any two variables, and applying the new variable to the knowledge entity.

15) The method as claimed in claim 14, further comprising the step of successively applying a series of new variables so as to accomplish further dimension reduction.

16) A method of enabling dynamic queries:
a) Providing an analytical engine, executed by a computer, that relies on one or more of a plurality of knowledge elements to enable intelligent modeling, wherein the analytical engine includes a data management system for accessing and processing the knowledge elements;
b) Establishing a series of questions that are directed to arriving at one or more particular outcomes; and
c) Applying the analytical engine so as to select one or more sequences of the series of questions based on answers given to the questions, so as to rapidly converge on the one or more particular outcomes.

17) A method of enabling distributed processing:
a) Providing an analytical engine, executed by a computer, that relies on one or more of a plurality of knowledge elements to enable intelligent modeling, wherein the analytical engine includes a data management system for accessing and processing the knowledge elements, whereby the analytical engine enables the combination of a plurality of knowledge entities into a single knowledge entity; and
b) Applying the intelligent modeling to the single knowledge entity.

18) The computer-implemented system claimed in claim 1, wherein the analytical engine:
a) Enables one or more records to be added or removed dynamically to or from the knowledge entity;
b) Enables one or more variables to be added or removed dynamically to or from the knowledge entity;
c) Enables use in the knowledge entity of one or more qualitative and/or quantitative variables; and
d) Supports a plurality of different data analysis methods.

19) The computer-implemented system claimed in claim 18, wherein the knowledge entity is portable to one or more remote computers.

20) The computer-implemented system claimed in claim 1, wherein the intelligent modeling applied to relevant knowledge elements enables one or more of:
a) credit scoring;
b) predicting portfolio value from market conditions and other relevant data;
c) credit card fraud detection based on credit card usage data and other relevant data;
d) process control based on data inputs from one or more process monitoring devices and other relevant data;
e) consumer response analysis based on consumer survey data, consumer purchasing behaviour data, demographics, and other relevant data;
f) health care diagnosis based on patient history data, patient diagnosis best practices data, and other relevant data;
g) security analysis predicting the identity of a subject from biometric measurement data and other relevant data;
h) inventory control analysis based on customer behaviour data, economic conditions and other relevant data;
i) sales prediction analysis based on previous sales, economic conditions and other relevant data;
j) computer game processing whereby the game strategy is dictated by the previous moves of one or more other players and other relevant data;
k) robot control whereby the movements of a robot are controlled based on robot monitoring data and other relevant data; and
l) A customized travel analysis whereby the favorite destination of a customer is predicted based on previous behavior and other relevant data; and

21) A computer program product for use on a computer system for enabling data analysis and process control comprising:
a) a computer usable medium; and
b) computer readable program code recorded on the computer useable medium, including:
i) program code that defines an analytical engine that relies on one or more of the plurality of knowledge elements to enable intelligent modeling, wherein the analytical engine includes a data management system for accessing and processing the knowledge elements.

22) The computer program product as claimed in claim 21, where the program code defining the analytical engine instructs the computer system to define one or more knowledge entities, each of which is comprised of at least one knowledge element.

23) The computer program product as claimed in claim 22, wherein the program code defining the analytical engine instructs the computer system to update dynamically the knowledge elements with a plurality of records and a plurality of variables.

24) The computer program product as claimed in claim 22, wherein the program code defining the analytical engine instructs the computer system to establish the knowledge entity so as to consist of a data matrix having a row and a column for each variable, and wherein the knowledge entity accumulates sets of combinations of knowledge elements for each variable in the intersection of the corresponding row and column.

25) The computer program product as claimed in claim 24, wherein the program code defining the analytical engine instructs the computer system to enable variables and/or records to be dynamically added to, and subtracted from, the knowledge entity.

26) The computer program product as claimed in claim 25, wherein the program code defining the analytical engine instructs the computer system to enable the deletion of a variable by deletion of the corresponding row and/or column, and wherein the knowledge entity remains operative after such deletion.

27) The computer program product claimed in claim 25, wherein the program code defining the analytical engine instructs the computer system to enable the addition of a variable by addition of a corresponding row and/or column to the knowledge entity, and wherein the knowledge entity remains operative after such addition.

28) The computer program product claimed in claim 25, wherein the program code defining the analytical engine instructs the computer system to enable the update of the knowledge entity without substantial re-training or re-calibration of the knowledge elements.

29) The computer program product claimed in claim 22, wherein the program code defining the analytical engine instructs the computer system to enable application to the knowledge entity of one or more of: incremental learning operations, parallel processing operations, scenario testing operations, dimension reduction operations, dynamic query operations or distributed processing operations.

30) A computer-implemented system as claimed in claim 1, wherein the analytical engine enables process control.

31) The computer-implemented system as claimed in claim 30, wherein the analytical engine enables fault diagnosis.

32) A method according to claim 11, wherein the method is implemented in a digital signal processor chip or any miniaturized processor medium.
